(19) United States
(12) Patent Application Publication
(10) Pub. No.: US 2023/0137540 A1
(43) Pub. Date: May 4, 2023

(54) FILTER

(71) Applicant: Q-FLO LIMITED, Sevenoaks (GB)

(72) Inventors: Liron Issman, Sevenoaks (GB); Brian Graves, Sevenoaks (GB); Jeronimo Terrones, Sevenoaks (GB); Shuki Yeshurun, Sevenoaks (GB); Meir Hefetz, Sevenoaks (GB); Martin Pick, Sevenoaks (GB); Adam Boies, Sevenoaks (GB)

(73) Assignee: Q-FLO LIMITED, Sevenoaks (GB)

(21) Appl. No.: 17/912,152

(22) PCT Filed: Mar. 19, 2021
(86) PCT No.: PCT/GB2021/050684

§ 371 Date: Sep. 16, 2022

(30) Foreign Application Priority Data
Mar. 20, 2020 (GB) 2004083.8

(51) Int. Cl. B01D 39/20; C01B 32/158

(52) U.S. Cl. CPC B01D 39/2065; C01B 32/158; B01D 2239/0241; B01D 2239/025; B01D 2239/0618; B01D 2239/0654; B01D 2221/16; B01D 2257/91

(57) ABSTRACT

The present invention relates to a filter comprising a self-supporting body of non-woven carbon nanotubes useful in the sequestration of an airborne virus.

The present invention relates to a filter, to an air treatment apparatus comprising the filter and to the use of a self-supporting body of non-woven carbon nanotubes in the sequestration of an airborne virus.

The presence of airborne viruses is a prevailing risk to public health. The global pandemic caused by the severe acute respiratory syndrome coronavirus 2 (SARS-CoV-2) has had a devastating effect on both human lives and the global economy. To combat this over the long term, the transmission of the disease must be disrupted by limiting the primary vectors for viral spread. Respiratory liquid aerosols (with droplet sizes <5 μm) are thought to be an important primary vector for many viruses including coronaviruses and are produced through expiration while coughing, speaking and breathing. Surgical masks and respirators may only offer limited protection against such viruses.

Respiratory particles that can penetrate into the lung can also remain suspended for hours and migrate over tens of meters via advection and diffusion, thus posing a hazard for indoor environments. These aerosols can contain active SARS-CoV-2 virions for at least three hours contributing to high infection rates in enclosed and crowded spaces. To mitigate these risks, air filtration in poorly ventilated (<3 air changes per hour) or air-recycling dominant environments has been proposed as a means to limit spread of the disease.

The present invention is based on the recognition that a self-supporting body of non-woven carbon nanotubes has desirable airborne virus sequestration capability. In particular, the self-supporting body of non-woven carbon nanotubes reduces the ambient concentration of viral particles (eg by viral trapping or deactivation) whilst allowing a high flux of gases at low static pressure loss. A filter incorporating the self-supporting body of non-woven carbon nanotubes can therefore achieve high aerosol filtration efficiency while exhibiting low-pressure drops. The increased surface area and the ability to lower gas flow drag due to the ‘slip’ mechanism enables non-zero velocity on the surface of the nanotubes. As such, the smaller the diameter of the nanotubes, the better the filter's performance.

Viewed from a first aspect the present invention provides a filter which is capable of sequestering an airborne virus comprising:
a framework; and
a self-supporting body of non-woven carbon nanotubes mounted on or in the framework.

The ability of the self-supporting body of non-woven carbon nanotubes to be easily shaped facilitates its deployment in an effective air filter. With the capability to optimize its thickness, mechanical properties (via the manufacturing process), shape and surface chemistry (eg by coating), the self-supporting body of non-woven carbon nanotubes is a versatile, cost-effective and high-end barrier solution for airborne viruses.

The framework may be rigid or flexible. The self-supporting body of non-woven carbon nanotubes may be rigid or flexible.

The filter may be a module (eg a cartridge). For this purpose, the framework is rigid. The filter may be part of (eg mountable or mounted in) an air treatment apparatus. The air treatment apparatus may be non-medical such as an air conditioner, air purifier or air humidifier or medical such as a mask, respirator, ventilator, respiratory protective device or breathing apparatus.

The filter may be face mountable. The filter may be (or be part of) a mask (eg a surgical mask, full face mask or half face mask), helmet, hood or visor.

The framework may be flexible. The flexible framework may be adapted or adaptable to attach to a face part.

The self-supporting body of non-woven carbon nanotubes may be face-mountable (eg human face-mountable) or head-mountable (eg human head-mountable). The self-supporting body of non-woven carbon nanotubes may be contoured to a face part (eg a human face part) or head part (eg a human head part). The self-supporting body of non-woven carbon nanotubes may be face-fitted.

Preferably the self-supporting body of non-woven carbon nanotubes is a monolayer of non-woven carbon nanotubes.

Preferably the self-supporting body of non-woven carbon nanotubes is a laminate. The layers of non-woven carbon nanotubes may be interdigitated. The layers of non-woven carbon nanotubes may be interleaved with layers of porous insulating material.

Particularly preferably the laminate is a bilayer. More preferably the bilayer is a layer of non-woven carbon nanotubes and a layer of a porous insulating material.

Preferably the porous insulating material is polyester.

In a preferred embodiment, the filter further comprises:
means for inactivating the virus.

The means for inactivating the virus may be an electromagnetic, electrical, microwave irradiation, infra-red (thermal) irradiation, ultra-violet irradiation, gamma irradiation or chemical means.

The chemical means may be a source of a gas or liquid. The chemical means may be a source of chlorine, chlorine dioxide, ozone, formaldehyde or glutaraldehyde. The chemical means may be a source of a high pH agent or low pH agent.

Preferably the means for inactivating the virus comprises an electric field generator for generating an electric field in the self-supporting body of non-woven carbon nanotubes.

The electric field may be a low voltage electric field (mV/cm) or high voltage electric field (kV/cm). The electric field generator may be a DC source or an AC source operable in capacitive or resistive mode. The DC source or AC source may be in an electrical circuit with or without a resistor.

Preferably the electric field generator is an AC source.

The AC source may be capable of applying an AC voltage in the range 0.3 to 6.0V. The AC source may be capable of applying an AC voltage at a frequency in the range 10 Hz to 20 MHz. The AC source may be capable of applying an AC voltage at a low frequency (for example a frequency in the range 50 to 500 Hz). The AC source may be capable of applying an AC voltage at a high frequency (for example a frequency in the range 10 to 20 MHz).

The ability of CNTs to conduct current at high AC frequencies allows coupling between virus molecules trapped by the filter and the applied AC current. At sufficiently high frequencies (eg 8.3 GHz) in the microwave region, dipolar coupling occurs leading to virus deactivation.

The DC source may be capable of applying a DC voltage in the range 0.1 to 50V, preferably 0.6 to 3.0V. The DC source may be cathodic or anodic. The DC source may be capable of applying pulsed DC. The DC source may be capable of applying a static DC voltage. The DC source may be capable of applying a DC voltage reversed periodically. The DC source may be capable of applying a pulsed voltage with fixed polarity. The DC source may be capable of applying a pulsed voltage with alternately reversed polarity.

The electric field generator may be a source of AC and DC. The electric field generator may be an AC source and a DC source. The electric field generator may be switchable between AC and DC.

Preferably the means for inactivating the virus comprises a thermal generator for generating heat (eg Ohmic heat) in the self-supporting body of non-woven carbon nanotubes.

The thermal generator may be capable of elevating the temperature of the self-supporting body of non-woven carbon nanotubes to a virus inactivation temperature (eg ≥80° C.).

The virus may be an aerosolised virus (eg a virus transmitted in an aerosol or droplets). The virus may be coronavirus, AAV, Nora, Vaccinia, HSV Herpes, Flu or MHV PRRSV. Preferably the virus is coronavirus (eg COVID-19).

The self-supporting body of non-woven carbon nanotubes may be pristine or functionalised.

The self-supporting body of non-woven carbon nanotubes may be hydrophobic or hydrophilic.

The self-supporting body of non-woven carbon nanotubes may be fibrous. For example, the self-supporting body of non-woven carbon nanotubes may be a fibre, wire, film, ribbon, strand, sheet, plate, mesh or mat.

The self-supporting body of non-woven carbon nanotubes may be substantially planar. The self-supporting body of non-woven carbon nanotubes may be substantially annular. The self-supporting body of non-woven carbon nanotubes may be substantially cylindrical.

The self-supporting body of non-woven carbon nanotubes may be coated or uncoated.

The self-supporting body of non-woven carbon nanotubes may be coated with a polymer (eg a conductive or non-conductive polymer). The polymer may be a thermoplastic or thermosetting polymer.

The self-supporting body of non-woven carbon nanotubes may be coated with a metal or metal oxide. The metal oxide may be copper oxide.

In a preferred embodiment, the self-supporting body of non-woven carbon nanotubes is coated with a non-conductive polymer. Preferably the non-conductive polymer is a fluoropolymer. Particularly preferred is polyvinylidene difluoride (PVDF) or a copolymer or terpolymer thereof.

The areal density of the self-supporting body of non-woven carbon nanotubes may be 60 gm⁻² or less. Preferably the areal density of the self-supporting body of non-woven carbon nanotubes is 30 gm⁻² or less. Particularly preferably the areal density of the self-supporting body of non-woven carbon nanotubes is 20 gm⁻² or less.

In a preferred embodiment, the areal density of the self-supporting body of non-woven carbon nanotubes is in the range 0.1 to 14 gm⁻².

The surface of the self-supporting body of non-woven carbon nanotubes may be substantially uniform. The surface of the self-supporting body of non-woven carbon nanotubes may be non-uniform. For example, the surface of the self-supporting body of non-woven carbon nanotubes may be crimped, corrugated or undulatory.

Preferably the thickness of the self-supporting body of non-woven carbon nanotubes is subject to variation by up to 20%.

The self-supporting body of non-woven carbon nanotubes may be provided with a polymer core. The polymer core may be an elastomer core or a thermosetting or thermoplastic polymer core.

In a preferred embodiment, the self-supporting body of non-woven carbon nanotubes is fitted with a pair of spaced apart electrodes.

Typically the filter exhibits a filter quality factor in the range 5 to 40 kPa⁻¹.

Preferably the self-supporting body of non-woven carbon nanotubes is obtainable or obtained from a process comprising:
(a) introducing a flow of metal catalyst or metal catalyst precursor into a temperature-controlled flow-through reactor;
(b) introducing a flow of a source of carbon into the temperature-controlled flow-through reactor;
(c) exposing the metal catalyst or metal catalyst precursor and source of carbon to temperature zones sufficient to generate particulate metal catalyst and to produce carbon nanotubes;
(d) displacing the carbon nanotubes as a continuous discharge through a discharge outlet of the temperature-controlled flow-through reactor;
(e) collecting the continuous discharge in the form of the self-supporting body of non-woven carbon nanotubes or in a form adaptable thereinto.

Typically the particulate metal catalyst is a nanoparticulate metal catalyst. Preferably the nanoparticles of the nanoparticulate metal catalyst have a mean diameter (eg a number, volume or surface mean diameter) in the range 1 to 50 nm (preferably 1 to 10 nm). Preferably 80% or more of the particles of the nanoparticulate metal catalyst have a diameter of less than 30 nm. Particularly preferably 80% or more of the particles of the nanoparticulate metal catalyst have a diameter of less than 12 nm. The concentration of the particulate metal catalyst may be in the range 10⁶ to 10¹⁰ particles cm⁻³.

Typically the metal catalyst is one or more of the group consisting of alkali metals, transition metals, rare earth elements (eg lanthanides) and actinides. Preferably the metal catalyst is one or more of the group consisting of transition metals, rare earth elements (eg lanthanides) and actinides.

Preferably the metal catalyst is at least one of the group consisting of Fe, Ru, Co, W, Cr, Mo, Rh, Ir, Os, Ni, Pd, Pt, Ru, Y, La, Ce, Mn, Pr, Nd, Tb, Dy, Ho, Er, Lu, Hf, Li and Gd. Preferably the metal catalyst is iron.

The metal catalyst precursor may be a metal complex or organometallic metal compound. Examples include iron pentacarbonyl, ferrocene or a ferrocenyl derivative (eg ferrocenyl sulphide).

Preferably the metal catalyst precursor is sulphur-containing. A metal catalyst precursor which is sulphur-containing may promote carbon nanotube growth.

Preferably the metal catalyst precursor is a sulphur-containing organometallic. Particularly preferably the metal catalyst precursor is a sulphur-containing iron organometallic. More preferably the metal catalyst precursor is a sulphur-containing ferrocenyl derivative. Yet more preferably the metal catalyst precursor is mono-(methylthio) ferrocene or bis-(methylthio) ferrocene.

The flow rate of the metal catalyst or metal catalyst precursor may be in the range 1 to 50 g/hour (eg about 7 g/hour).

The metal catalyst or metal catalyst precursor may be introduced in step (a) together with a sulphur-containing additive. The sulphur-containing additive may promote carbon nanotube growth. The sulphur-containing additive may be thiophene, iron sulphide, a sulphur-containing ferrocenyl derivative (eg ferrocenyl sulphide), hydrogen sulphide or carbon disulphide.

In a preferred embodiment, the sulphur-containing additive is thiophene or carbon disulphide. Particularly preferably the sulphur-containing additive is thiophene.

In a preferred embodiment, the metal catalyst precursor is ferrocene optionally together with a sulphur-containing additive (preferably thiophene or carbon disulphide).

The flow rate of the sulphur-containing additive may be in the range 0.1 to 10 g/hour (eg about 5 g/hour).

The metal catalyst or metal catalyst precursor introduced in step (a) may be in a gaseous, liquid or solid form. The metal catalyst or metal catalyst precursor may be introduced in step (a) with a non-metal catalyst modifier or precursor thereof. The non-metal catalyst modifier may be chalcogen-containing (eg sulphur-containing).

The generation of particulate metal catalyst may be initiated in step (c) by thermal decomposition or dissociation of the metal catalyst or metal catalyst precursor into metal species (eg atoms, radicals or ions). The generation of particulate metal catalyst in step (c) may comprise nucleation of the metal species into nucleated metal species (eg clusters). The generation of particulate metal catalyst may comprise growth of the nucleated metal species into the particulate metal catalyst.

The metal catalyst or metal catalyst precursor may be introduced (eg injected) in step (a) in a linear, axial, vortical, helical, laminar or turbulent flow path. The metal catalyst or metal catalyst precursor may be introduced at a plurality of locations.

In step (a), the metal catalyst or metal catalyst precursor may be introduced axially or radially into the temperature-controlled flow-through reactor. The metal catalyst or metal catalyst precursor may be introduced axially through a probe or injector.

The metal catalyst or metal catalyst precursor may be in a mixture with a carrier gas. The carrier gas is typically one or more of nitrogen, argon, helium or hydrogen. The mass flow of the metal catalyst or metal catalyst precursor in admixture with the carrier gas is generally in the range 10 to 30 lpm.

Before step (b), the source of carbon may be heated.

Before step (b), the source of carbon may be subjected to radiative heat transfer by a source of infrared, visible, ultraviolet or x-ray energy.

In step (b) the source of carbon may be introduced (eg injected) in a linear, axial, vortical, helical, laminar or turbulent flow path.

In step (b), the source of carbon may be introduced axially or radially into the temperature-controlled flow-through reactor. The source of carbon may be introduced axially through a probe or injector. The source of carbon may be introduced at a plurality of locations. The source of carbon may be an optionally substituted and/or optionally hydroxylated aromatic or aliphatic, acyclic or cyclic hydrocarbon (eg alkyne, alkane or alkene) which is optionally interrupted by one or more heteroatoms (eg oxygen). Preferred is an optionally halogenated C₁₋₆-hydrocarbon (eg methane, propane, ethylene, acetylene or tetrachloroethylene), an optionally mono-, di- or tri-substituted benzene derivative (eg toluene) or C₁₋₆-alcohol (eg ethanol).

Preferably the source of carbon is methane optionally (but preferably) in the presence of an optionally substituted and/or optionally hydroxylated aromatic or aliphatic, acyclic or cyclic hydrocarbon (eg alkyne, alkane or alkene) which is optionally interrupted by one or more heteroatoms (eg oxygen).

The source of carbon may be a C₁₋₆-hydrocarbon such as methane, ethylene or acetylene.

The source of carbon may be an alcohol such as ethanol or butanol.

The source of carbon may be an aromatic hydrocarbon such as benzene or toluene.

In a preferred embodiment, the source of carbon is methane optionally in the presence of propane or acetylene.

The flow rate of the source of carbon may be in the range 50 to 30000 sccm (eg 2000 sccm). Typically in step (b), the source of carbon is introduced with a carrier gas such as helium, hydrogen, nitrogen or argon.

The flow rate of the carrier gas may be in the range 1000 to 50000 sccm (eg 30000 sccm). In a preferred embodiment, steps (a) and (b) are concurrent. For this purpose, the metal catalyst or metal catalyst precursor is preferably suspended or dissolved in the source of carbon. Particularly preferably the metal catalyst or metal catalyst precursor and a sulphur-containing additive are suspended or dissolved in the source of carbon. For example, ferrocene and thiophene may be dissolved in an organic solvent such as butanol, ethanol, benzene or toluene and the solution may be introduced (eg injected) into the temperature-controlled flow-through reactor.

The carbon nanotubes may be single-walled and/or multi-walled carbon nanotubes. In step (c), the carbon nanotubes structure may take the form of a 3D continuous network (eg an aerogel).

The temperature-controlled flow-through reactor may be cylindrical or another geometry. The temperature-controlled flow-through reactor may be substantially vertical or horizontal. Preferably the temperature-controlled flow-through reactor is substantially horizontal.

The walls of the temperature-controlled flow-through reactor may be selectively cooled by exposure to a cooling fluid such as water, liquid nitrogen or liquid helium.

The temperature-controlled flow-through reactor may be adapted to provide an axial temperature gradient. The axial temperature gradient may be non-uniform (eg stepped). The temperature of the temperature-controlled flow-through reactor may be controlled by resistive heating, plasma or laser.

Preferably the temperature profile in the temperature-controlled flow-through reactor is substantially parabolic.

The temperature zones sufficient to generate particulate metal catalyst and to produce carbon nanotubes may extend over at least the range 600 to 1300° C.

The temperature-controlled flow-through reactor may be adapted to introduce reactants by an injection nozzle, lance, probe or a multi-orificial injector (eg a shower head injector).

Step (d) may be carried out by a mechanical, electrostatic or magnetic force.

Step (e) may be carried out mechanically. For example, step (e) may be carried out on a rotary spindle or drum.

The process may further comprise cutting, chopping, shaping, laying, flattening, stretching, unrolling, aligning, combing, heating, vibrating or reinforcing the self-supporting body of non-woven carbon nanotubes.

The process may further comprise chemically adapting the self-supporting body of non-woven carbon nanotubes.

The process may further comprise densifying the self-supporting body of non-woven carbon nanotubes (eg by a factor in the range 1.5 to 2.5). Densification is typically followed by air-drying. Densification may be carried out in an organic liquid. A preferred organic liquid is acetone or methanol.

The process may further comprise coating the self-supporting body of non-woven carbon nanotubes.

Preferably the electrical conductivity of the self-supporting body of non-woven carbon nanotubes is in the range 10³ to 10⁵ S/m, particularly preferably in the range 10000 to 80000 S/m.

The areal density of the self-supporting body of non-woven carbon nanotubes may be varied by varying the duration of step (e).

The process may further comprise mechanically stretching the self-supporting body of non-woven carbon nanotubes.

Preferably the average pore size of the self-supporting body of non-woven carbon nanotubes is in the range 75 to 150 nm.

Preferably the pore size distribution of the self-supporting body of non-woven carbon nanotubes is 75 to 150 nm.

Step (e) may be carried out on a bobbin. Preferably the bobbin is covered with a porous insulating material for forming a self-supporting body of non-woven carbon in the form of a laminate (eg a bilayer).

Viewed from a further aspect the present invention provides an air treatment apparatus comprising a filter as hereinbefore defined.

The air treatment apparatus may be non-medical or medical.

The air treatment apparatus may be an air conditioner, air purifier, air humidifier, respirator, ventilator, respiratory protective device, mask, hood or breathing apparatus.

The filter may be movable through an airflow to be filtered. The filter may be in the form of a belt. The belt may be mounted on a plurality of rollers in a non-linear configuration (eg a serpentine configuration).

An airflow may be moved through the filter. For example, the air treatment apparatus may further comprise a blower (eg a fan) for moving the airflow through the filter. The airflow may be recirculatory.

In a mask, the self-supporting body of non-woven carbon nanotubes may be a laminate (eg a bilayer). The layers of non-woven carbon nanotubes may be interdigitated. The layers of non-woven carbon nanotubes may be interleaved with layers of porous insulating material.

In a mask, the self-supporting body of non-woven carbon nanotubes is typically hydrophilic.

In an air conditioner, the self-supporting body of non-woven carbon nanotubes is typically hydrophobic.

Viewed from a yet further aspect the present invention provides the use of a self-supporting body of non-woven carbon nanotubes as hereinbefore defined or of a filter as hereinbefore defined in airborne virus sequestration.

The present invention will now be described in a non-limitative sense with reference to the accompanying Figures in which:

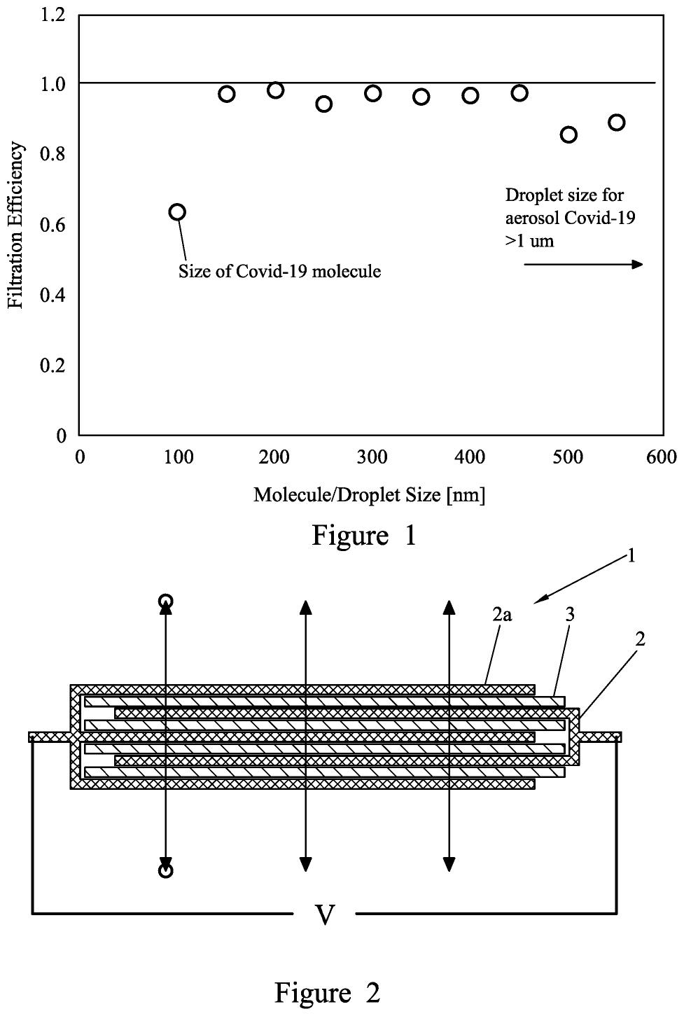

FIG. 1 illustrates the filtration efficiency of a sheet of non-woven CNT material;

FIG. 2 is a cross-sectional view of a first embodiment of a filter according to the invention;

FIG. 3 is a cross-sectional view of a second embodiment of a filter according to the invention;

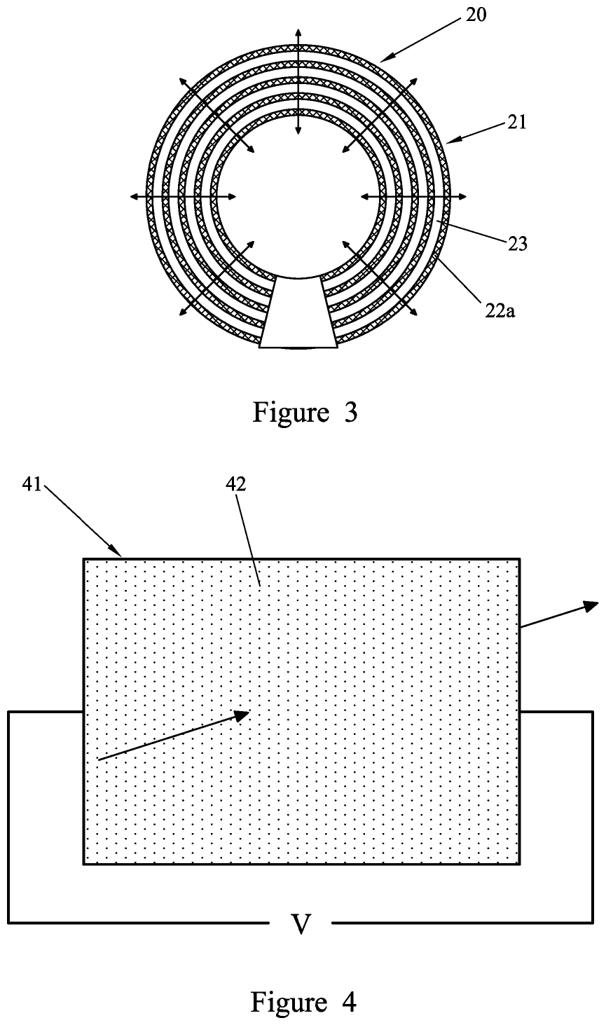

FIG. 4 is a plan view of a third embodiment of a filter according to the invention;

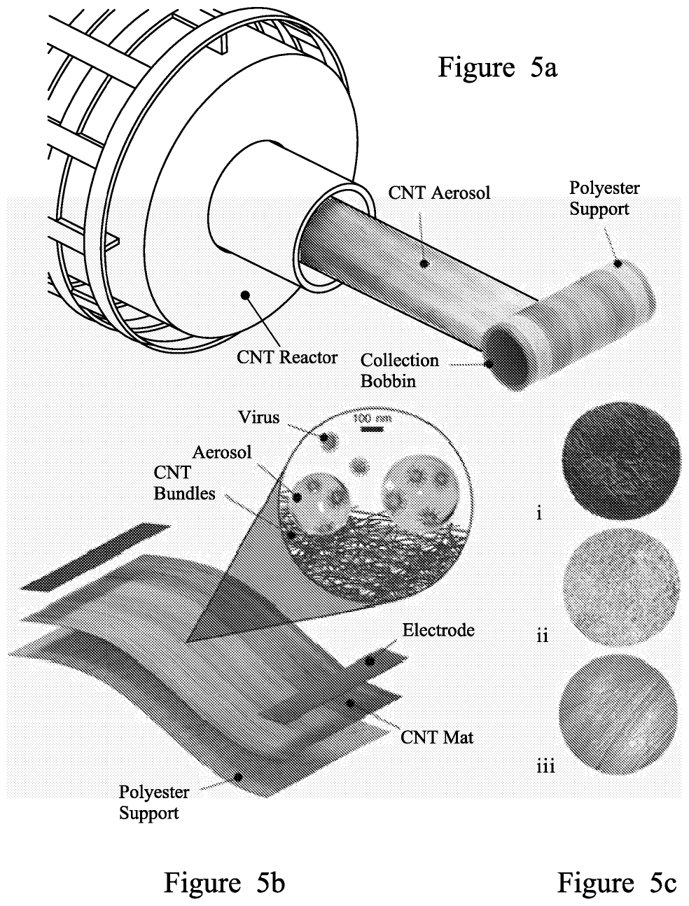

FIG. 5 relates to a hybrid CNT filter which is a fourth embodiment of the invention. (a) An adapted direct spinning method using a collection bobbin covered with a polyester backing for the in-situ production of the hybrid CNT filter. (b) An illustration showing the concept of the hybrid CNT filter. The hybrid CNT filter can retain SARS-CoV-2 virions and aerosols containing them and can be actively sterilized via resistive heating enabled by applying a potential between two electrodes. (c) Photographs showing (i) The upper layer made from a micrometre thin CNT mat. (ii) The lower layer made from porous polyester. (iii) The fine structure of the hybrid CNT filter revealed by a backlight;

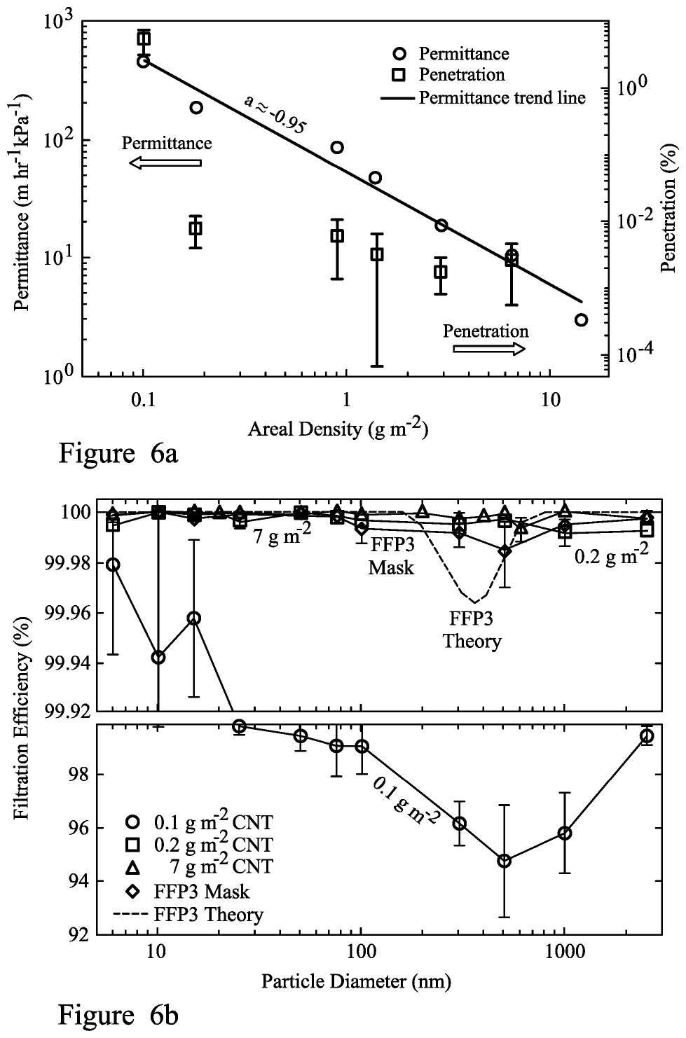

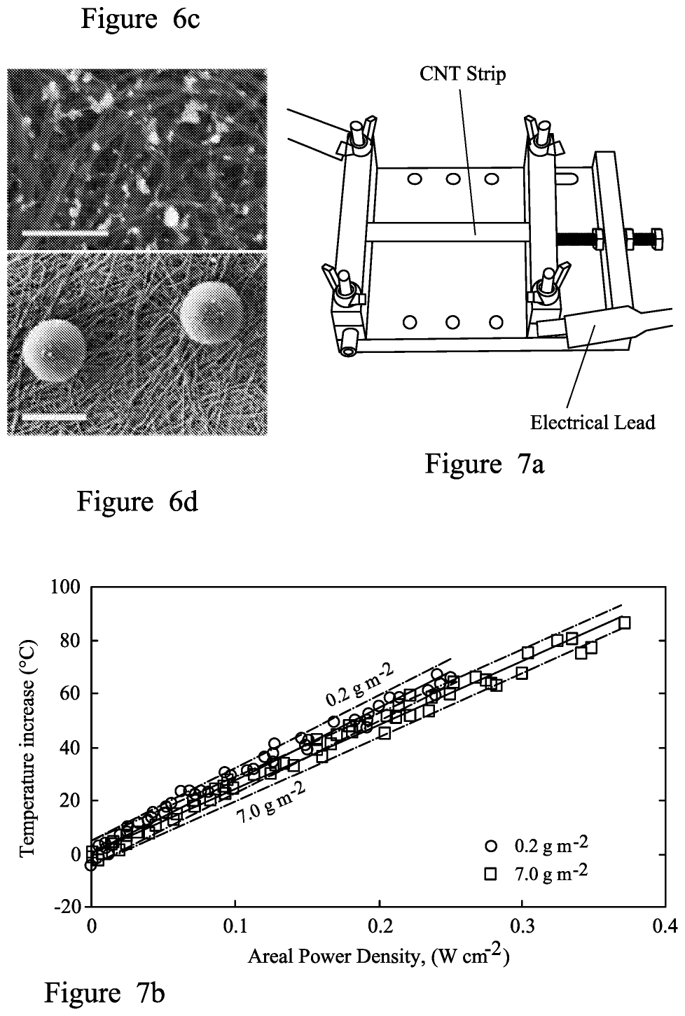

FIG. 6. Permittance and filtration efficiency of a CNT filter. (a) Permittance (blue circles, left axis) and penetration (red squares, right axis) as a function of areal density. The permeability trend line (blue) follows a slope of −0.946 fitting well with the theoretical value of −1. The penetration values differ slightly with areal density with only the 0.1 g m⁻² material showing an increase associated with macroscopic defects. (b) Filtration efficiency as a function of particle diameter showing that CNT filters (apart from the 0.1 g m⁻² material) exhibit constant filtration efficiency across the full particle range with no apparent ‘U’ shaped profile. The filtration efficiency is comparable to an H13 class HEPA filter. FFP3 mask material shows an experimental (solid grey line) and theoretical (dashed grey line) classical ‘U’ shaped behaviour with a most penetrating particle size (MPPS) in the range of hundreds of nanometres. (c) SEM image showing the surface of the CNT filter after filtration of Ag nanoparticles (5-120 nm) aerosol. Due to Brownian motion, nanoparticles even smaller than the apparent pore size can be efficiently retained (Scale bar, 500 nm). (d) SEM image showing polystyrene microbeads (2 μm) deposited on the filter surface. Microparticles are significantly larger than the pore sizes of the filter and are mechanically sieved (Scale bar, 2 μm). Error bars denote standard deviations using at least three different sample;

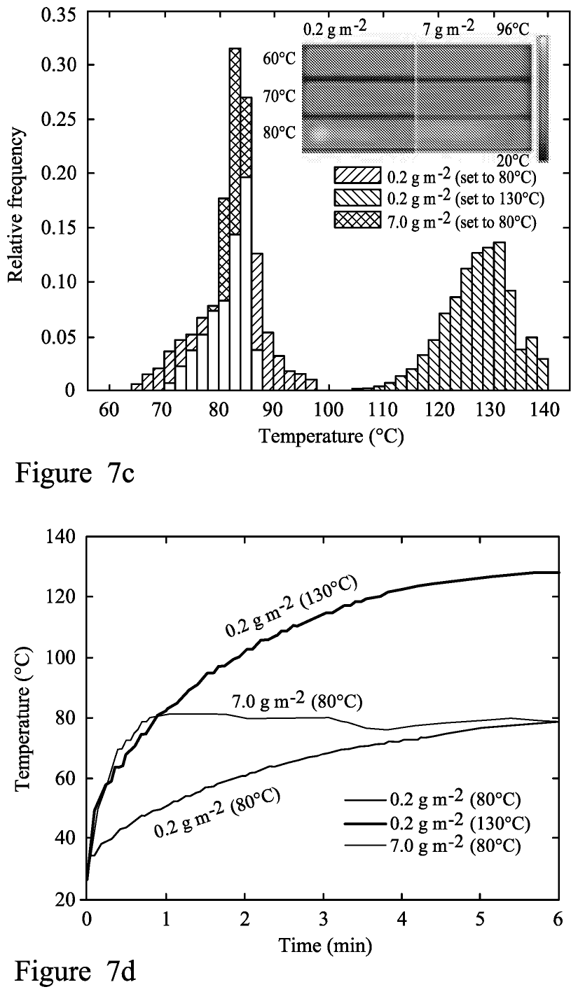

FIG. 7. Electrothermal behaviour of the CNT filter. (a) A bespoke heating jig used for electrothermal experiments. The design allowed CNT sample strips with various dimensions to be used and ensured firm electrical contact on both ends. (b) Temperature increase (ΔT) as a function of areal power density shows a linear correlation at this temperature range. Slopes of 242.01 and 272.96° C. cm² W⁻¹ respectively for a 7 g m⁻² self-supporting CNT filter and a 0.2 g m⁻² polyester-backed hybrid CNT filter. The regions bordered by dashed lines enclose 90% of data points (±4.65° C. for the 0.2 g m⁻² hybrid CNT filter and ±4.42° C. for the 7 g m⁻² self-supporting CNT filter). (c) The uniformity of areal heating of the filter shown by thermal imaging reveals a homogenous pattern (inset). Histogram made by pixel-by-pixel temperature analysis shows mean temperature values of 82° C. in both cases with a standard deviation of 3 and 6° C. for the 7 g m⁻² self-supporting CNT filter (red bars) and 0.2 g m⁻² hybrid CNT filter (blue bars) respectively. The 0.2 g m⁻² hybrid CNT filter set to a temperature of 130° C. (dark red bars) is shown to ensure no domain is colder than 100° C. (d) The heating response time shows it takes 3.54±0.24 s for the 0.2 g m⁻² hybrid CNT filters to heat from 30 to 70° C. (red line) and the 7 g m⁻² self-supporting CNT filters do the same in only 0.48±0.24 s (blue line). By increasing the setpoint to 130° C. (dark red line), the 0.2 g m⁻² hybrid CNT filter shows a comparable response rate to the one shown with the 7 g m⁻² self-supporting CNT filter;

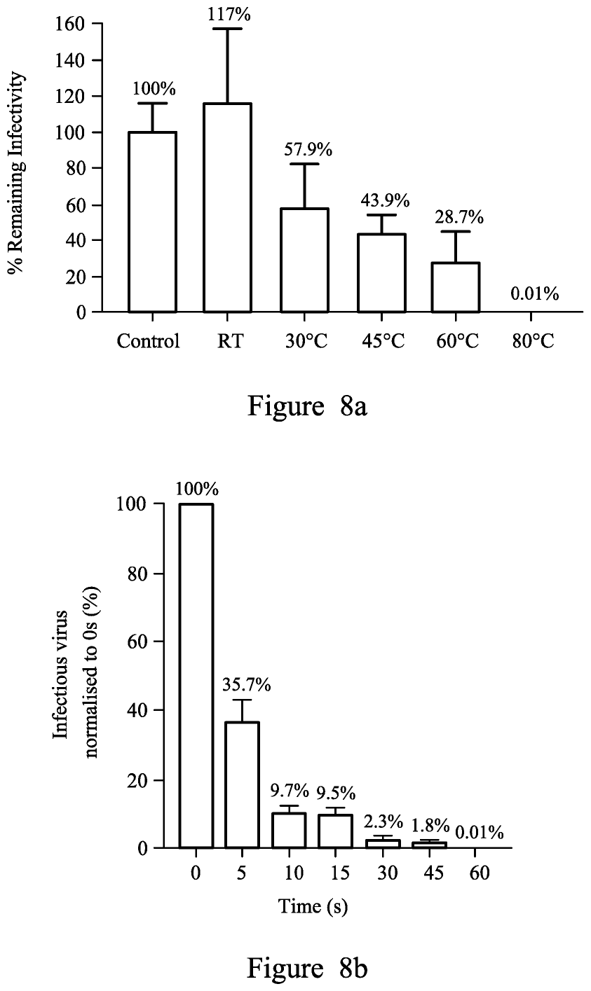

FIG. 8. Viral infectivity due to thermal exposure. Results show the remaining infectivity levels of the animal coronavirus on CNT mats heated to various temperatures or for different periods. (a) 5 μL virus-containing droplets were heated for a period of 90 s. Control is based on the infectivity level of the stock solution. RT (room temperature) shows the infectivity levels of samples that did not undergo active heating. Full inactivation is seen when the CNT mats were heated to a temperature not lower than 80° C. (b) 0.4 μL virus-containing droplets were heated to a temperature of 80° C. Full inactivation is seen after a period of 60 s. Error bars represent a standard deviation based on at least three repeats;

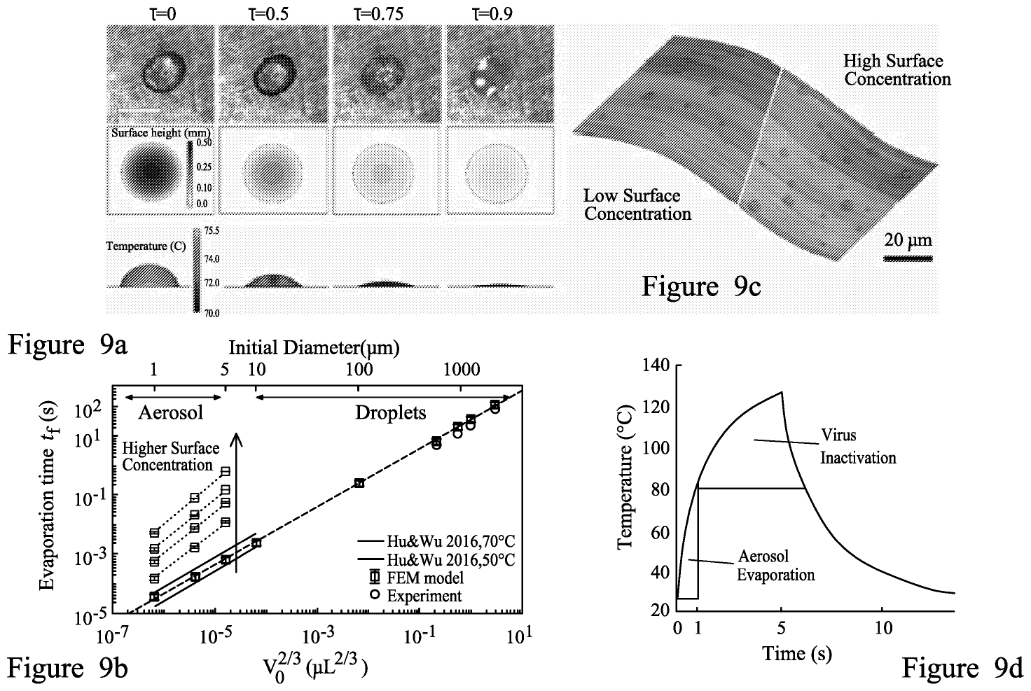

FIG. 9. Droplet and aerosol drying on a heated CNT filter. (a) Images of a 0.4 μL droplet evaporating on a CNT filter at T=80° C. at advancing τ, taken as the ratio of time and full evaporation time, t_{f}. (top line) Images confirm a “constant contact radius” (CCR) evaporation mode with t_{f}=15 s and scale bar, 1 mm. (middle line) Plan view of FEM numerical results for droplet surface height corresponds to the experimental conditions. (bottom line) Cross-section of the FEM results of droplet temperature profile with t_{f}=19 s. (b) Plotted results of t_{f} as a function of the initial droplet volume, V₀^{2/3} (equivalent initial droplet diameters on the secondary x-axis). FEM results assume a contact angle of 70° with upper and lower error bars denoting contact angles 100° and 30° respectively. Experimental measurements (red circles) agree with FEM results (black squares). The linear correlation (black dashed line) indicates aerosols (≤5 μm) will evaporate in t_{f}<1 ms which agrees with the analytical quasi-steady-state Hu and Wu model (Hu, D.; Wu, H. Volume Evolution of Small Sessile Droplets Evaporating in Stick-Slip Mode. Phys. Rev. E 2016, 93, 42805 (https://doi.org/10.1103/PHysRevE.93.042805). Coloured lines represent different surface concentrations based on filtration time (1, 5, 15 and 60 min for red, orange, blue and turquoise respectively). (c) Illustration representing thermal behaviour of the CNT filter as a function of aerosol loading with higher concentrations leading to lower temperatures. (d) Plot of measured temperature response of the 0.2 g m⁻² hybrid CNT filter with a 5 s heat flash set to 130° C.;

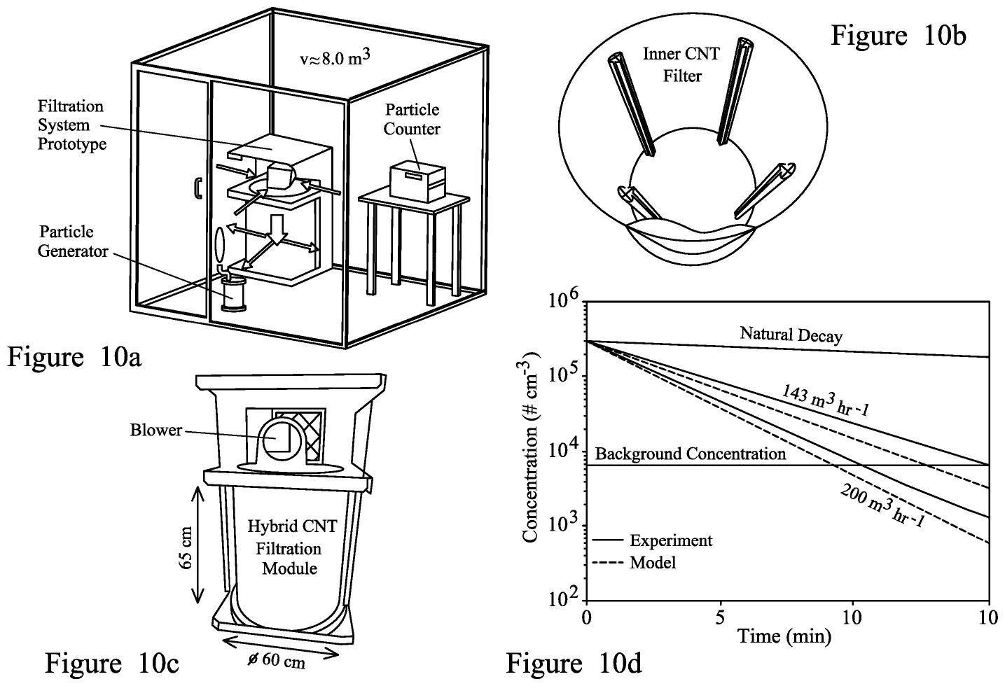

FIG. 10. Developing and testing a prototype active filtration unit. (a) An illustration showing the setup of the prototype unit. The prototype unit was placed in an enclosed volume (8.7 m³). NaCl nanocrystals (with a geometric mean diameter of 119 nm) were introduced to the chamber through a 20-jet collision nebulizer. The aerosol concentration was continuously monitored using a condensed particle counter (CPC). (b) A photograph showing the construction of the filtration module based on the 0.2 g m⁻² hybrid CNT filter. (c) A photograph of the internal parts of the prototype unit. Surrounding contaminated air is drawn to the upper chamber by a centrifugal blower, then blown downwards into the internal volume of the filtration module. The air is purified by passing through the filter outwards and consequently recycled back to the environment. (d) A decay plot showing an exponential decay behaviour recorded during active filtration with flow rates of 134 (blue) and 200 (red) m³ hr⁻¹. Lowering the pollutant number concentration to background levels took ˜15 and 11 min using a flow rate of 143 and 200 m³ hr⁻¹ respectively. The experimental results (full lines) fit nicely with the theoretical model (dashed lines) dealing with decay rates of pollutants in fully mixed confined volumes. Filtration decay rates were decoupled from the measured total decay rates by normalizing those with the natural decay rate (green line);

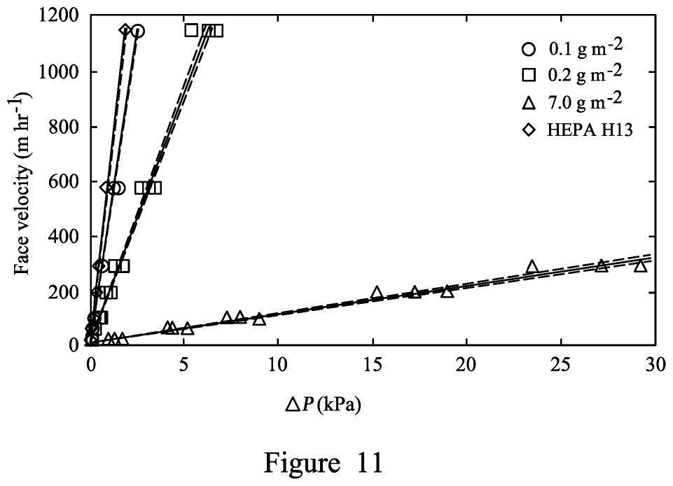

FIG. 11. Face velocity and pressure drop. Pressure drop measured for varying face velocities in three different CNT filters (0.1, 0.2 and 7 g m⁻²) and a HEPA H13 class filter. Data was collected from at least three samples. The dashed lines represent ±one standard error of the linear regression slope. Slopes are 604.3, 458.1, 183.2 and 10.3 m³ hr⁻¹ m⁻² kPa⁻¹ for the HEPA H13, 0.1, 0.2 and 7 g m⁻² filters respectively;

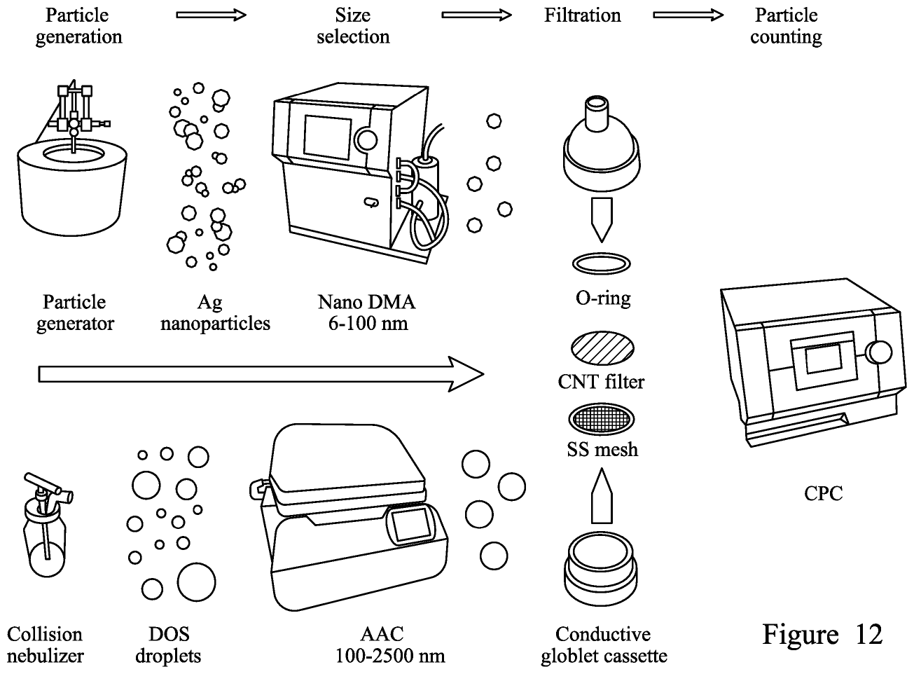

FIG. 12. Filtration efficiency test setup. Ag nanoparticles were generated by a bespoke particle generator and size selected by a Nano DMA (Top). DOS droplets were produced by a collision nebulizer and size selected by an AAC (Bottom). Aerosols were passed through the CNT filter material mounted in a conductive goblet cassette and sandwiched between an O-ring and a SS mesh. Aerosols passing through the filter were counted by the use of a CPC;

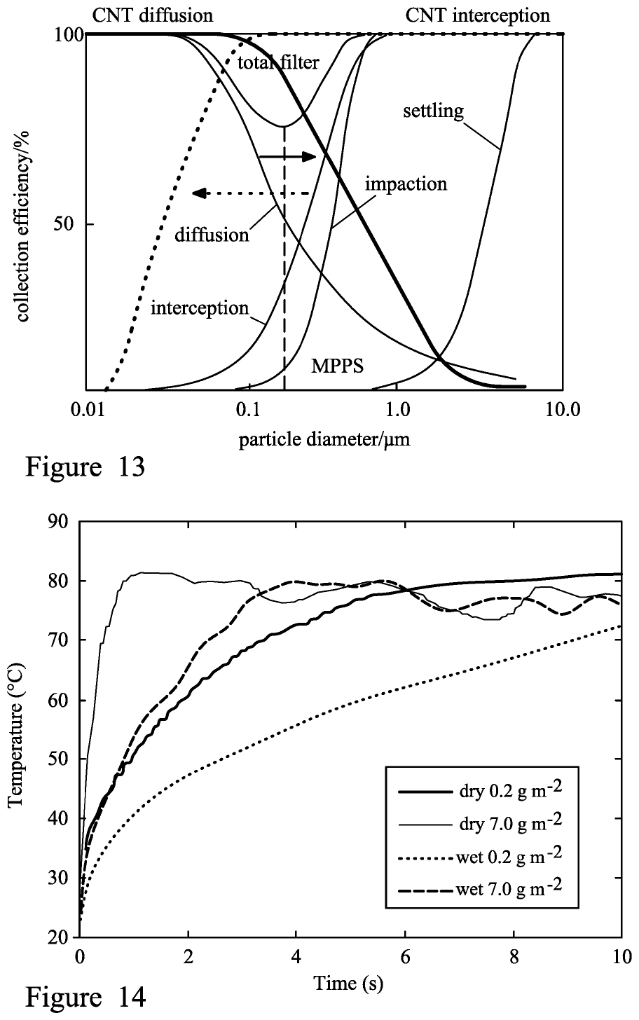

FIG. 13. Filter efficiency for individual single fibre mechanisms. Filtration efficiency mechanisms of individual microfibres (and total efficiency) shown by the black curves. Enhanced diffusion (blue curve) and interception (red curve) single fibre efficiencies are illustrated qualitatively for nanofibres (CNT bundles);

FIG. 14. The heating response rate of CNT filters. The heating rate of the 0.2 and 7 g m⁻² CNT filters in a dry (solid line) state and when sprayed with approximately 5 μL of DIW (dashed line). When coated with water the response rate is much slower due to water evaporation and the added heat capacity of water;

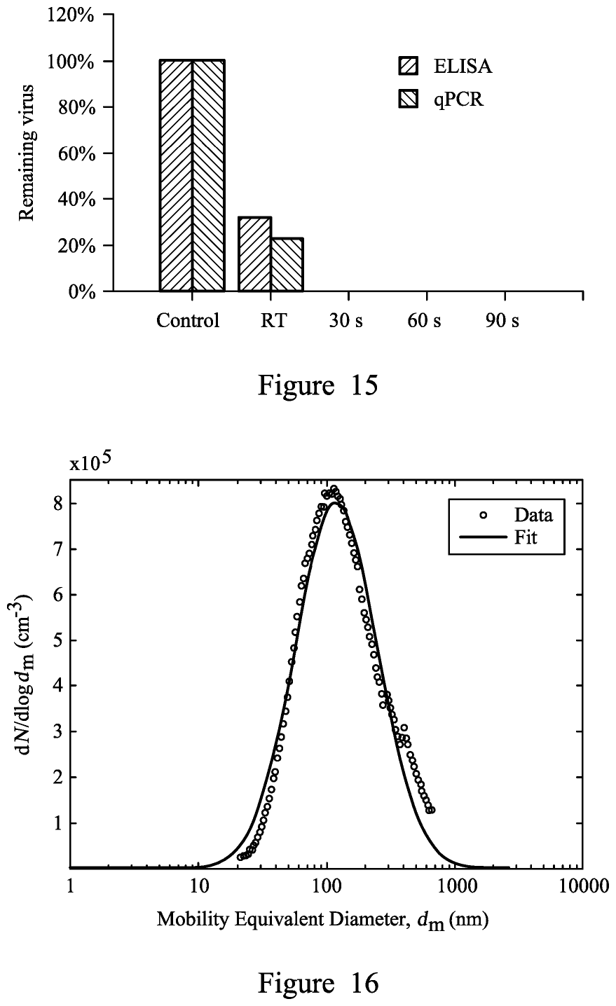

FIG. 15. AAV9 viral survival ratio due to heat treatment. Results showing the survivability ratio (compared to the control) of 0.4 μL AAV9-containing droplets heated to a temperature of 80° C. on a CNT mat. Results were based on ELISA (grey) and qPCR (black) analysis. Control is based on the genomic copies found in the stock solution. RT (room temperature) shows the infectivity levels of samples that did not undergo active heating. Full inactivation is seen when the CNT mats were heated for 30 s;

FIG. 16. Particle size distribution of NaCl aerosols. The size distribution of the aerosols atomized in the confirmed volume. Data (circles) is based on an average of 10 runs. Fitting (red line) shows a count geometric mean diameter and a geometric standard deviation of 118.77 and 2.08 nm respectively; and

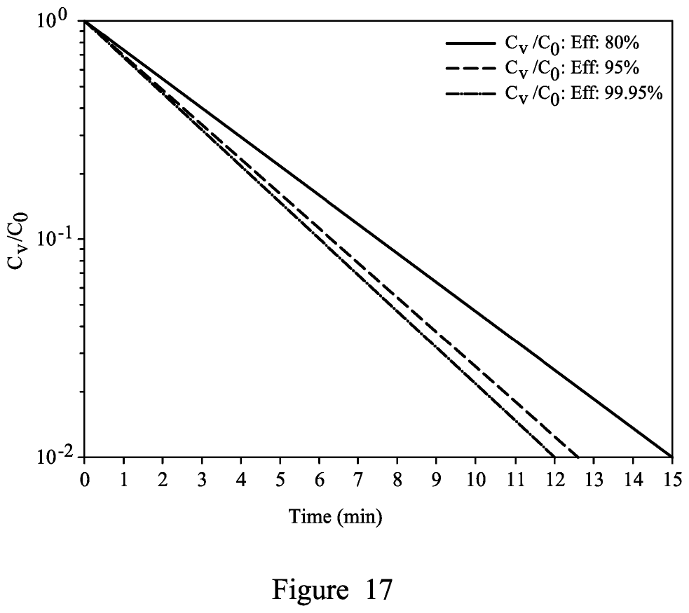

FIG. 17. Aerosol decay rate using different filter types. The decay rates in a fully mixed room using an air-recycling filtration system equipped with an H13 (dashed-dot line), E11 (dashed line) HEPA filters and a non-HEPA filter (full line) having a filtration efficiency of 99.95%, 95% and 80% respectively.

### EXAMPLE 1

The filtration efficiency of a sheet of non-woven CNT material was measured and is shown in FIG. 1. This revealed that the filtration efficiency was high for particles of the size of aerosolised coronavirus (denoted Covid-19) but is highly dependent on face velocity at the filter surface.

### EXAMPLE 2

FIG. 2 is a cross-sectional view of a first embodiment of a filter according to the invention designated generally by reference numeral 1. The filter 1 comprises a laminate of CNT mats 2 in which individual mats 2a are arranged interdigitally and interleaved with thin layers of porous insulating material 3. The filter 1 takes the form of a cartridge that can be loaded into a face mask. An airflow is shown as double ended arrows and viruses are sequestered by the laminate of CNT mats 2. The restriction of airflow is proportional to the number of mats 2a and is inversely proportional to the gas permeability of the CNT and insulating layers 3 and the area of each mat 2a and insulating layer 3.

A voltage (DC, pulsed DC or low frequency AC) is applied by a voltage source V which serves to inactivate viruses sequestered by the laminate of CNT mats 2. The advantage of using thin mats 2a and thin layers of porous insulating material 3 is that the field strength (V/mm) across them is greater for a given voltage. A separate sterilizing station may be provided to allow a long period of deep sterilization (eg using chlorine as a disinfectant). Alternatively a separate heater (eg a DC heater) may be provided to elevate the temperature to a high temperature (eg 100° C.).

The insulating layers 3 are preferably as thin as possible (to provide the highest field strength for minimum applied voltage) and should have high gas permeability. Candidate materials include thin paper tissue or open-cell foam. Flammable material would need to be fireproofed because there may be some risk of ignition from a spark (especially if the filter is damaged). By way of example, medium-weight paper tissue is 200 μm thick so 9V would create a field strength of 45,000 V/m. Preferably the insulating layers 3 are chemically resistant to a sterilising gas (eg chlorine) to allow the filter 1 to be sterilised and re-used.

The applied voltage (approximately in the order of increasing supply power required) may be one or more of:
a. A static DC voltage.
b. A DC voltage reversed periodically
c. A pulsed voltage with fixed polarity
d. A pulsed voltage with alternately reversed polarity
e. An AC voltage of low frequency (for example 50-500 Hz)
f. An AC voltage of higher frequency (for example 13.4 MHz)

The power consumption of a simple DC version would be very low (probably determined by the extent to which condensation occurs in the insulating layers 3). This may not be significant for indoor use but could be for outdoor use in cold weather (for example by ambulance paramedics). An RF version is probably to be avoided in a clinical setting because of potential for interference with critical medical electronic devices. A filter (including electronics to monitor operation) can be expected to operate for at least a full shift on a standard 9V battery (6LR61) which could be rechargeable. Supervisory functions could include a test of battery voltage leakage current (damp or contaminated filter) and could also include time in use, time since last sterilised and other safety and administrative functions. These could be automatically linked to a wireless control system which could also log the ID and position of the user.

### EXAMPLE 3

FIG. 3 is a cross-sectional view of a second embodiment of a filter according to the invention designated generally by reference numeral 20. The filter 20 comprises a self-supporting cylindrical body of CNT mats 21 which provides a large filtration area in a compact volume. The cylindrical body of CNT mats 21 is essentially a “rolled-up” version of the laminate of CNT mats 2 shown in FIG. 2. The cylindrical body of CNT mats 21 comprises individual mats 22a separated by thin layers of porous insulating material 23.

### EXAMPLE 4

FIG. 4 is a plan view of a third embodiment of a filter according to the invention designated generally by reference numeral 41. The filter 41 comprises a CNT mat 42 in an electrical circuit with a voltage source V. An airflow is shown as an arrow and viruses are sequestered by the CNT mat 42.

### EXAMPLE 5—A POLYESTER-BACKED HYBRID CNT FILTER

This Example relates to mass producible air filters using polyester-backed hybrid CNT mats. Filtration efficiencies were measured up to 99.999% and ultra-thin mats with low areal density (0.1 g m⁻²) exhibited pressure drops comparable to commercial HEPA filters. The electrically conductive filters were self-sterilized by thermal flashes via resistive heating to temperatures above 80° C. within seconds or less. Such temperatures achieved full deactivation of a beta-coronavirus and an adeno-associated virus retained on the surface. A filtration prototype unit equipped with a CNT filter module (˜1.2 m²) was shown to achieve air purification of 99% of a room within 10 minutes at 26 air changes per hour.

The hybrid CNT mat was produced by an adaptation of the floating catalyst CVD (FCCVD) process outlined in Li, Y.-L.; Kinloch, I. A.; Windle, A. H. Direct Spinning of Carbon Nanotube Fibres from Chemical Vapor Deposition Synthesis. Science 2004, 304 (5668), 276-278 (see https://doi.org/10.1126/science.1094982). Tests showed that the filter had an efficiency equivalent to a HEPA filter which was independent of its thickness, while air permeability followed a Darcy's law-related trend. In contrast to standard microfibre filters, no apparent minimum filtration efficiency was detected for any particular particle size. The hybrid CNT filters have high permeability, high capture efficiency and low thermal mass. Thermal analysis demonstrated that hybrid CNT filters can act as fast-response heating elements and virus infectivity trials confirmed that total viral inactivation is achievable due to thermal exposure in a matter of seconds. Modelling indicated that adsorbed aerosols should readily desiccate once the power is applied thereby ensuring that efficient energy management is achievable.

### Results and Discussion

Pressure Drop

Hybrid CNT mats with ultra-low areal density (<1 g m⁻²) were developed to enable robust structures with high gas permeability. CNT aerogels were spun onto a porous polyester backing material (PET apertured spunlace, N. R. Spuntech Inc.; see FIG. 5a) via a continuous facile process. Upon collection, a bilayered hybrid CNT mat is formed (see FIG. 5b) consisting of a thin CNT layer (thickness of several hundred nanometres to several micrometres, see FIG. 5ci) on top of a porous polyester backing of 0.4 mm thickness (see FIG. 5cii). The hybrid CNT mat was designed to minimize airflow resistance while maintaining mechanical integrity, ease of handling and high filtration efficiency. The CNT layer was sufficiently thin to readily transmit light when visible backlighting is used to reveal its fine structure (see FIG. 5ciii). The advantage of the synthesis and deposition process is that it does not require any post-treatment thereby preserving the single-step nature of the process.

To assess the permeability of the hybrid CNT filter, the pressure drop was measured and permeability was determined by Darcy's law for laminar flow through a porous medium

$$U = \frac{K}{μ L} Δ p = \frac{K ρ}{{μρ}_{s}} Δ p = k Δ p , \qquad ( 1 )$$

where U is the air's velocity perpendicular to the face of the filter, K is the intrinsic permeability, ρ is the CNT bulk density, μ is the dynamic viscosity of air, L is the CNT layer thickness and Δp is the pressure drop developed across the filtration matrix.

While CNT layer thickness is inherently variable when the length scales of film thickness and pores are of similar orders of magnitude, the areal density ρₛ serves as a reliable surrogate for scaling. The intrinsic permeability of the CNTs can be combined with the areal density, bulk density and air viscosity to produce a coefficient (the filter permittance (k≡Kρ/μρₛ)) which directly relates the flow through the filter to the corresponding pressure drop. As expected, the permittance varied inversely with areal density giving absolute value of the power-law fit near unity (a=−0.95) (see FIG. 6a). The intrinsic permeability of the material is remarkably stable (K=6.01×10⁻¹⁷±8×10⁻¹⁹ m²) over the samples of varying areal densities (0.1 to ˜14 g m²). Thus minimizing the CNT layer thickness provides a means for reducing the pressure drop for a given flow rate, while the filtration efficiency is maintained.

Filtration Efficiency

A wide range of CNT particle size (6-2500 nm) was chosen to assess filtration capabilities and to find the so-called, most penetrating particle size (MPPS). Solid Ag nanoparticles were used as a test aerosol for sizes between 6 nm and 100 nm and low volatility dioctyl sebacate (DOS) oil droplets were used for sizes between 300 nm and 2.5 μm. This range covers the sizes of typical viruses (AAV ˜20 nm to SARS-CoV-2 ˜100 nm) to aerosolized droplets that contain the virus (˜0.5 to >5 μm). As shown in FIG. 6b, the CNT filters exhibit high and nearly constant filtration efficiency (>99.95%, the inverse of penetration) across the range of particle diameters for all areal densities at 0.2 g m⁻² or above. The CNT filters with ρₛ≥0.2 g m² have efficiencies that are comparable to H13 class HEPA filters. SEM images indicate the extremes of the particle filtration from diffusive collection for small particles (eg<100 nm, see FIG. 6c) to interception/impaction at larger sizes (>1 μm, see FIG. 6d). The hybrid CNT filters exhibit no MPPS at the transition from diffusive to interceptive filtration, in contrast to what is typically observed for classical microfibre filtration materials (see FFP3 mask in FIG. 6b) which exhibit a minima in filtration efficiency at the MPPS. Penetration values remained constant even when the CNT filters were “thinned” by more than an order of magnitude. Only the thinnest material produced with an areal density of 0.1 g m⁻² showed a significant increase in the penetration ratio (see FIG. 6b). At such low areal densities, defects in synthesis or handling lead to macroscopic defects in the CNT mat resulting in a significant drop in filtration efficiency.

The high filtration efficiency without an apparent MPPS is a result of the nanostructure of the hybrid CNT filter (ie bundles of several to few tens of CNTs) that are orders of magnitude smaller (10-50 nm) than the microfibres (0.8-20 μm) used in traditional filters. Traditional filtration curves such as the experimental and theoretical model for a 3M FFP3 filter medium (grey full and dashed lines in FIG. 6b) exhibit a characteristic minimum filtration efficiency that tends to be between 100 and 500 nm of 99.97% in compliance with manufacturer claims. In this size range, neither diffusion due to Brownian motion nor interception due to particles coming within one particle radius or less from a filter fibre are fully effective. As opposed to microfibres, the solidity and surface area of CNT filters are greater than traditional filters, allowing for overlap in filtration by interception and diffusion regimes (see FIG. 13). This results in a material that does not exhibit an MPPS but rather where filtration efficiency is dictated purely by material defects in its homogeneity.

The filter quality factor is a common means of assessing the ratio of filtration efficiency in comparison to inherent pressure drop

$${Q}_{f} = \frac{- ln ( P )}{Δ p} \qquad ( 2 )$$

where Q_{f} is the quality factor and P is the penetration ratio at the MPPS. The quality factor of the 7, 0.2 and 0.1 g m² filters is 5.07, 45.56 and 39.75 kPa⁻¹ respectively which are within a factor ˜2 of a HEPA H13 filter (Camfil). Although the 0.1 g m² filter shows an EPA E10 class filtration efficiency, it can still be adequate for aerosol filtration in air-recycling systems as the ultimate pathogen removal efficiency is a function of both pressure drop and filtration efficiency. For recycling air filtration systems, the removal function has a relatively weak dependence on filtration efficiency when recycled at a constant volumetric flow rate (FIG. 17). Nevertheless further research and characterization were focused on the 0.2 gm⁻² hybrid CNT filter and the 7 gm⁻² self-supporting CNT filter which displayed better inherent homogeneity.

CNT Filters as Efficient and Fast-Response Heating Elements

As CNTs are electrically conductive, it is possible to deactivate viral components by thermally denaturing captured pathogens through resistive heating. To assess the power consumption-to-heat ratio of the hybrid and self-supporting CNT mats, sample strips were mounted on a bespoke heating jig (see FIG. 7a) and analysed using an infrared thermal camera. As heat loss is approximately proportional to surface area, the power consumption per unit area is comparable for different areal densities and resistances. As seen in FIG. 7b, the behaviour of both mats is linear for temperature increases of ΔT<100° C. with gradients that represent the power density normalized heating of 242 and 273° C. cm² W⁻¹ for areal densities of the mats (7 and 0.2 g m⁻²) respectively. The linear dependence of ΔT with applied power suggests that heat conduction and convection are the primary mechanisms (∝ΔT¹⁻) for heat loss, rather than radiation (∝ΔT⁴) which will dominate at larger temperature differences between the filter surface and environment. The higher normalized heating for the hybrid CNT mat suggests that it loses slightly less heat than the self-supporting CNT mat, primarily because of the thermal insulation of the polyester backing and the reduced thermal conductance of the thinner CNT layer. The sample strips used in the analysis typically had a resistance of 4Ω (7 g m⁻²) and 150Ω (0.2 g m⁻²) thereby maintaining a surface temperature of 80° C. Voltages of 3 and 16 V were used to produce currents of 0.75 and 0.11 A in the 7 and 0.2 g m² mats respectively. Generally it was found that a power density in the range 0.20-0.25 W cm² can reach and sustain a temperature of 80° C. which is higher than the 70° C. required to inactivate viruses such as adeno-associated virus, hepatitis E virus or SARS-CoV-2.

To assess heating uniformity, thermal imaging was used as summarized in FIG. 7c. The insert shows thermal images of the two sample strips at different average temperatures while the histogram gives the pixel by pixel (˜100 μm×100 μm) temperature. The thermal uniformity at a mean temperature of 82° C. is quantified by a standard deviation of 3 and 6° C. for the 7 and 0.2 g m² mats respectively. The increased thermal homogeneity of thicker samples is due to the greater cross-sectional area of the conductive CNTs (120-140 W m⁻¹ K⁻¹). To eliminate cooler domains, a higher setpoint temperature was also analysed. As seen in the dark red histogram, when the setpoint was adjusted to 130° C. the coldest point did not fall below 100° C.

The thermal response time provides an upper bound to the rate at which viruses can be deactivated. The thermal response was assessed using a frame-by-frame analysis of the mean temperature in thermal videos while the sample strip was heated to varying setpoints. As seen in FIG. 7d, when the setpoint is 80° C. both mats show short characteristic times of heating of <6 s due to the combined material heat capacities (˜800 J kg⁻¹K⁻¹) and ultra-low areal density (0.2 to 7 g m⁻²) resulting in a low areal heat capacity (<6 J m⁻² K⁻¹). The low heat capacity of the filters is desirable as it allows temperatures sufficient for viral deactivation to be reached with lower power consumption, leading to quick and efficient flash sterilizing. While it took 3.54±0.24 s for the 0.2 g m⁻² hybrid CNT mat to heat from 30 to 70° C. (red line), the 7 g m² self-supporting CNT mat did the same in only 0.48±0.24 s (blue line). The slower response of the hybrid CNT mat is due to the additional thermal inertia of the polyester (˜10-fold increase). However by increasing the setpoint to 130° C. (dark red line), the 0.2 g m⁻² hybrid CNT mat showed a comparable response rate to the 7 g m⁻² self-supporting CNT mat. These results confirm that once the correct heating parameters are established, viral deactivating temperatures above 70° C. can be achieved in <1 s to ensure that heating time is not the rate-limiting factor for viral deactivation.

Viral Deactivation

Cell infectivity tests were run using a mouse coronavirus (MHV-A59). This is a beta-coronavirus (within the same group as SARS-CoV-2 and SARS) that can be handled outside a containment level 3 laboratory. Initial experiments were run to find a “deactivation temperature” showing a significant drop in virus infectivity. 7 g m⁻² self-supporting CNT mats were mounted on the heating jig (see FIG. 7a) and pipetted with 5 μL virus-loaded droplets (concentration ˜8×10⁷ infectious units mL⁻¹). Experiments were conducted on a reference sample (blue disposable lab coat), a control sample (0 V) and four more samples at variable voltages producing a surface temperature not lower than 30, 45, 60 and 80° C. (1.3, 2.0, 3.2 and 4.0 V respectively). As portrayed in the reference column (0 V) seen in FIG. 8a, the experimental protocol is adequate for detecting virus infectivity using samples acquired from CNT mats. Even by applying low voltages, an evident decrease in virus infectivity is witnessed at temperatures less than 70° C. (which is the typical deactivation temperature of SARS-CoV-2 and SARS virus). This phenomenon suggests that direct surface oxidation may be an additional deactivation mechanism. At an applied potential of 4 V, a four-order magnitude drop in infectivity is measured to the limit of detection (LOD). The full deactivation of the virus at this voltage is a result of full droplet evaporation witnessed within 90 seconds, directly exposing the virions to CNTs at a surface temperature higher than 70° C.

The next set of experiments was run to scan for the minimal time needed to achieve total deactivation when applying a 4 V potential. In these experiments, smaller, virus-loaded droplets (0.4 μL) were pipetted onto the CNT strips while a heating cycle was run for 5, 10, 15, 30, 45 and 60 s. As seen in FIG. 8b, even though no full evaporation was achieved after 5 seconds, there was an evident decrease in infectivity due to possible surface oxidation resulting in loss of function of ˜60% from the initial viral load. Heating for 30 and 45 s led to the evaporation of the droplets and was associated with a significant deactivation level of about one order of magnitude. A heating period of 60 s led to full deactivation (LOD) which was likely a result of prolonged exposure to the deactivation temperature. Further viral deactivation experiments were done on adeno-associated virus 9 (AAV9) using the above method. Full deactivation of AAV9 contained in 0.2 μL droplets was achieved after 30 s when the CNT mat was heated to 80° C. (see FIG. 15).

These results demonstrate that the principle of resistive heating for self-sterilization of CNT filters is valid for a virus from the same group as SARS-CoV-2. For experimental sensitivity, the droplets used in these experiments were loaded in extremely high concentrations, many orders of magnitude higher than estimated to be exhaled by individuals spreading the virus. As such, it is assumed that in a real-life application the pathogen loading should be lower thereby making it easier to sterilize to an acceptable level. The results show that full deactivation is achievable on millimetre-sized droplets. These droplets require significantly higher energy for evaporation in comparison to micro-sized aerosols (<5 μm). Having a better theoretical understanding of the dynamics of aerosol evaporation on a CNT mat should give insight into the timeframe needed for full evaporation and thus total deactivation of virus-containing aerosols.

Droplet and Aerosol Drying on a Heated CNT Mat

The evaporation process of surface-bound aqueous droplets was explored with experimental and computational methods. A computational model simulated the diffusion-controlled evaporation of a droplet on a heated CNT mat. The model was validated for droplets in the continuum regime using light microscopy imaging on several millimetre to sub-millimetre water droplets undergoing evaporation on a heated CNT mat (see FIG. 9a). The measurements showed that there is no change in the droplet base area during most of the evaporation period. This indicates that water droplets on the surface follow a “constant contact radius” (CCR) evaporation mode which is described further in Picknett, R. G.; Bexon, R. The Evaporation of Sessile or Pendant Drops in Still Air. J. Colloid Interface Sci. 1977, 61 (2), 336-350. (https://doi.org/10.1016/0021-9797(77)90396-4). The CCR evaporation mode was embedded in the model under consideration of convection within the droplet and diffusion of water vapor from the interface to the ambient environment.

FIG. 9a shows that there is good agreement temporally between the measured and modelled evaporation process for a measured 0.4 μL water droplet. The minor overestimation of the evaporation time by the model (19 s) compared with the experimental result (15 s) can be explained by modelling inaccuracies due to the absence of the account for water infiltration into the CNT mat. An agreement between experiment and theory for 0.1, 0.4, 1 and 5 μL droplets is visualized in FIG. 9b, in which the red circles (experimental) corroborate the black (modelled) squares. The results are in line with the reported power-law temporal scaling for CCR evaporation dynamics (evaporation time t_{f} and initial volume Vₒ related by t_{f}∝V₀^{2/3}). According to the CCR power law (dashed black line) it can be inferred that the evaporation time of micro- and nano-droplets should be less than several milliseconds. These results fit well with an analytical quasi-steady-state model by Hu and Wu supra for the evaporation of small sessile droplets under isothermal conditions. The results derived from cases where the interface temperature was ˜70° C. lie well between the 50 to 70° C. isotherms of the Hu and Wu model portrayed by the green lines (FIG. 9b). Although the model required adaptations to better fit the current scenario in which a constant volumetric heat is generated at a known rate by the CNT mat, such an agreement gives confidence to its applicability.

After establishing the validity of the model, other parameters influencing the evaporation time were assessed. The filtration period which directly affects the aerosol surface concentration has a significant impact on the evaporation time. As seen in FIG. 9b, the higher the aerosol surface concentration (represented by squares turning from red to orange, blue and turquoise), the longer the evaporation period becomes, reaching fractions of seconds for aerosols with an initial diameter of 5 μm. As the schematic in FIG. 9c depicts, the simulation showed that as more droplets are captured by the CNT mat, the energy flux to each surface-bound droplet decreases. The reduced energy flux leads to a lower droplet interface temperature and longer evaporation time. However, as seen in the dynamic thermal behaviour (FIG. 7d) and illustrated in FIG. 9d even with an evaporation timescale on the order of a few hundreds of milliseconds, all aerosols should evaporate well within a 5 s, 130° C. flash pulse (yellow zone). Once all aerosols completely evaporate, the virions will be directly exposed to a surface temperature higher than 80° C. which has been shown to deactivate the modelled virus. These results indicate that viral deactivation can be achieved using short flash pulses thereby ensuring the high thermal efficiency of an active filter system. It also gives appropriate timescales for optimization between flash heating intervals and pulse duration to balance energy consumption and viral deactivation of in-use filters.

Performance Evaluation of a Prototype Unit

As CNT mats can be produced in large quantities, it was possible to produce a prototype unit comprising a full-scale hybrid CNT filtration module fitted to a conventional recirculating filter unit. As illustrated in FIG. 10a, the prototype unit was designed to draw ambient air by a centrifugal blower (RG175/2000, ebm-papst UK) and to direct the air outwards through a cylindrical filter module. The filtered air was recycled back to the ambient air thus reducing the airborne particle and droplet concentration in the environment. As shown in FIG. 10b, the filtration module was produced by fitting ˜1.2 m² of the 0.2 g m⁻² hybrid CNT mat on a cylindrical stainless-steel coarse mesh so that the CNT layer faced inwards to ensure mechanical support. The module was then fitted into the filtration unit (see FIG. 10c). As illustrated in FIG. 10a, the efficiency of particle reduction was measured within an enclosed volume (˜8.0 m³) after introducing a significant concentration (˜3×10⁵ #cm⁻³) of NaCl nanocrystals acting as a model aerosol. The count geometric mean diameter of the nanocrystals was adjusted to ˜120 nm (FIG. 16) to correspond to a typical MPPS for filter media thereby representing the most challenging test aerosol (and the approximate size of SARS-CoV-2 virion). To evaluate efficiency in purifying enclosed environments, the prototype unit was operated using two flow rates (143 and 200 m³ hr⁻¹) which correspond to 16 and 23 air changes per hour (ACH) of the internal volume which is in line with current guidelines for isolation rooms (>12 ACH). The decay rate of the suspended particles was monitored using a condensation particle counter. To properly decouple the decay rate resulting from active filtration from the total rate, the natural decay rate (achieved due to leaks, diffusive losses) was subtracted from the total decay rate. From FIG. 10d a characteristic exponential decay is apparent. Lowering the pollutant number concentration to background levels (˜6.5×10³ #cm⁻³) only by filtration, took approximately 15 and 11 minutes using a flow rate of 143 and 200 m³ hr⁻¹ respectively. In comparison by extrapolation of the green line, natural decay should do the same within ˜350 minutes. The experimental results (solid lines) correspond well with the theoretical model (dashed lines) that assumes the suspended particles are fully mixed within the enclosed volume (see equation S9). A slight deviation is seen at very low particle concentrations (<3×10² #cm⁻³) due to minor leaks from the ambient environment inwards to the confined volume. Overall these results show a promising application for hybrid CNT mats in a full-scale filtration system.

### CONCLUSIONS

The results show that active virus hybrid CNT filters exhibit excellent filtration efficiency (HEPA H13 level) while maintaining a low pressure drop. The filter can be flash heated to 130° C. within seconds leading to full viral inactivation. Accommodating the filter in a large filtration module (˜1.2 m²) installed in a prototype unit showed that a 10-fold decrease in air contamination in several minutes is achievable. Such units deployed in poorly ventilated and crowded environments (eg offices, public transportation, leisure and recreational centres) can have a material impact on fighting the viral spread of airborne diseases such as COVID-19 and seasonal influenza which has been shown to inflict a total economic burden equivalent to $87.1 billion in the United States alone

Measurement Techniques

Filtration Efficiency and SEM Imaging

The filtration efficiency tests were carried out on disc-shaped samples (d=25 mm) inserted into a conductive cassette blank (SureSeal cassette blanks, SKC). A conductive housing was essential to minimize electrostatic losses, particularly for particles smaller than ˜50 nm. For firm mounting and to ensure proper circumferential sealing, the disc samples were sandwiched between a stainless-steel mesh support and a silicone rubber O-ring (OD=25 mm; ID=20 mm). The tests were carried out using particles having a mobility diameter range of 6-2500 nm. Tests carried out in the range of 6-100 nm used Ag nanoparticles generated by a bespoke particle generator which produces silver vapor that later recondenses into nanoparticles. The silver resides inside a quartz test tube set into a dedicated furnace. The generator was heated to a temperature range of 1280-1320° C., running at a nitrogen flow of 2.2-2.5 standard litres per minute (slpm; HEPA filtered, BOC). The Ag nanoparticles were size-selected to discrete, nearly-monodisperse (geometric standard deviation ˜1.05) mobility diameters of 6, 10, 15, 25, 50, 75, and 100 nm using a TSI-Differential Mobility Analyzer (DMA) with a 3085 DMA column and a 3080 electrostatic classifier. Analysis done in the range of 100-2500 nm used Dioctyl sebacate (DOS, Sigma Aldrich, purity ≥90%)) aerosol droplets created by a single-jet collision nebulizer (CH Technologies) running at nitrogen flows of 0.5-1 slpm. DOS droplets were size-selected by a Cambustion-aerodynamic aerosol classifier (AAC) to discrete and again nearly-monodisperse mobility diameters of 300, 500, 1000, and 2500 nm. As the AAC classifies particles using a particle's aerodynamic diameter, the appropriate conversion from aerodynamic to mobility diameter was used as shown in Equation S6 (see below). Ag and DOS particle concentrations downstream of the cassette were analysed by TSI-Ultrafine Condensation Particle Counters (UCPC) 3025A and 3776 respectively (see FIG. 12). Particle concentration measurements were performed for each selected size in a specified sequence of (1) running an empty cassette used as a blank run; (2) running a cassette loaded with a polyester backing (in the case of a hybrid filter); (3) running a cassette loaded with a designated CNT filter. Each measurement was repeated on three different samples with a nitrogen flow of 0.3 slpm through the filtration cassette. Filtration efficiency was calculated by the following equation:

$$E ( {d}_{p} ) = \frac{{C}_{upstream} ( {d}_{p} ) - {C}_{downstream} ( {d}_{p} )}{{C}_{upstream} ( {d}_{p} )} \times 100 \% \qquad ( 3 )$$

where E (dₚ) is the fractional particle filtration efficiency, Cᵤₚₛₜᵣₑₐₘ(dₚ) and C_{downstream}(dₚ) are the number concentration of aerosolized particles measured without and with the filter respectively.

Two CNT filter mats for SEM imaging were made. The first was prepared by collecting aerosolized Ag nanoparticles (with a size range of 5-120 nm) for 45 minutes. The second was produced by applying a 10 μL droplet of aqueous suspended 2 μm polystyrene beads (Merck) diluted by a 1:100 ratio with deionized water (DIW), the droplet was air-dried at ambient temperature. The filter surface was imaged using a MIRA3 field emission gun-SEM (Tescan). Imaging was done at an acceleration voltage of 1 kV using the E-T SE detector (polystyrene beads) and 5 kV using the In-Beam SE detector (Ag nanoparticles) at a working distance of 3-5 mm. No conductive coating was added.

Filter Pressure Drop

The filter pressure drop tests were carried out on the same disc-shaped samples and cassettes described above. The volumetric flow was controlled from 0.1 to 6 slpm using a mass flow controller (Alicat) and suction was provided by a scroll vacuum pump (nXDS, Edwards). The pressure drop across the filter was measured using a differential pressure manometer (HD750, Extech Instruments) connected to the cassette inlet and outlet. All measurements were corrected by subtracting the inherent pressure drop of the blank filter cartridge.

Electrothermal Analysis

Electrothermal analyses of the self-supporting CNT and hybrid CNT mats were carried out with a FLIR T650sc infrared camera (640×480 px resolution, 7.5-14 μm spectral sensitivity, 24 mm f/1.0 optics) and a bespoke heating jig. The jig consisted of a sample holder with two adjustable parallel brass bar electrodes to which samples of different sizes (lengths between 75 and 120 mm and widths up to 50 mm) could be clamped (FIG. 7a). The electrodes were connected to the terminals of a DC power supply (EX2020R, AIM-TTI instruments). To minimize the effects of forced convection due to stray air currents, no fans or blowers were used in the vicinity of a running experiment and the jig was situated in a deep glass container.

Temperature versus power measurements were recorded by manually stepping the voltage applied to a 75×10 mm CNT sample strip while monitoring the average temperature within a 420 by 55 pixels square (encompassing most of the strip) with the camera's built-in software. At each setpoint, the current was recorded directly from the power supply console. The voltage step size and maximum voltages depended on the resistance of the sample (inversely proportional to its areal density). Each experiment was repeated on at least three different samples. Still images captured during the heat-up experiments were used to assess the heating uniformity of samples using both the “FLIR tools” software for a qualitative visual examination and a custom MatLab script for pixel-by-pixel quantitative analysis (code included in the SI appendix) to export pixel temperature information from the images.

The dynamic heating and cooling of the samples were characterized by recording thermal videos while manually switching the power supply on and off. The voltage was selected so samples would reach a stable temperature of around 80° C. (or 130° C.). A Matlab script (SI appendix) was then used to extract the average temperature of the sample (from a 420 px by 55 px crop of the frame) and the timestamp of each frame in the video. For each case, the results from a minimum of 10 heat-up (and when relevant, cool-down) cycles were averaged to get the reported results.

Viral Thermal Inactivation and Infectivity Tests

Tests were carried out on mouse coronavirus (MHV-A59) as a surrogate. MHV-A59 is a beta-coronavirus within the same group as SARS and SARS-CoV-2. Dedicated host cells were grown for a week and then plated in 96 well plates. 1 mL aliquots of media for elution were prepared. 7 g m⁻² CNT strips were mounted on a dedicated heating jig (FIG. 7a). Droplets containing a concentration of ˜8×10⁷ infectious units mL⁻¹ (TCID50) in a protein-rich solution with a volume of 5 or 0.2 μL were pipetted along the strip (a total of four drops). The droplets were undisturbed for a minute to let natural adsorption occur. The CNT strips were heated to various temperatures (RT, 30, 45, 60, 80° C.) for a period of 90 s (in the case of the 5 μL droplets) or to various heating periods (0, 5, 10, 15, 30, 45, 60 s) at a temperature of 80° C. (in the case of the 0.2 μL droplets). Control experiments were done on a blue disposable lab coat (which does not absorb water). CNT strips were cut into four sections and transferred to elution tubes to be vortexed for 10 s and then put on ice until ready to titrate. 8×10-fold dilutions of each biological repeat in media with dextran were performed. Media in 96 well plates containing cells with media containing 2% FCS and DEAE dextran (which promotes infection) was replaced. 50 μL of viral dilution was transferred into 4 rows per biological sample into 96 well plates containing cells. Cells were incubated at 37° C. 5% CO₂ for 3-5 days. Plates were scored for cytopathogenic effect (CPE).

Droplet Evaporation—Experimental and Modelling

Experiments for visualizing the droplet evaporation process were run on a 110×40 mm 7 gm⁻² CNT sample. The sample was placed in the strip-heating jig described above using a gauge length of 75 mm. The sample was heated to an average temperature of 80° C. by applying a voltage of 4.35 V exerting a current of 1.76 A which equates to an areal power density of 0.255 W cm⁻². DIW droplets were pipetted onto the surface with volumes of 0.1, 0.4, 1 and 5 μL. Each evaporation run was repeated at least three times. The image and video acquisition of the droplet evaporation was carried out using a Dino-Lite AM4113T USB microscope (AnMo Electronics Corporation) at a magnification of X45. Image analysis was done using the Dino-Lite software.

A computational model was developed to simulate the diffusion-controlled evaporation of a water droplet on a CNT mat with COMSOL Multiphysics (version 5.5). The model adopted a 2D axisymmetric geometry that revolved into a cylindrical domain including the CNT mat, the water droplet and the ambient air. The overall height of the domain was 1,600 times the height of the droplet, to reduce the influence of evaporation on the ambient conditions, which were maintained constant at 25° C. and 60% relative humidity. The radius of the domain was 40 times the base radius of a 0.4 μL droplet unless otherwise specified, to be consistent with the relative length scale used in the experiment. More details about other simulation parameters, along with the governing physics and the boundary conditions used in the simulation are covered in the supplementary information below (see section 5).

Performance Evaluation of a CNT Filter-Based Prototype

The filtration unit was placed in a chamber with a volume of 8 m³ made of plexiglass that was interconnected with Rexroth frames (BOSCH). A background scan of the particle concentration within the chamber was taken before each measurement. A 20-jet collision nebulizer (CH Technologies) was positioned on the floor of the chamber, filled with a 20% w/w NaCl (>99.7%, Fisher Scientific) in DIW solution (volume 300 mL). Nitrogen (HEPA filtered, BOC) was delivered to the nebulizer, through an MFC, at a flow rate of 37 slpm atomizing the solution and filling the chamber with NaCl nanoparticles recorded to have a count median diameter and geometric standard deviation of 118.77 and 2.08 nm respectively (see FIG. 16). Filtration experiments were performed at a flow rate of 143 and 200 m³ hr⁻¹ and without any active filtration to determine the natural decay rate. After a two-minute aerosolization period, the flow rate to the nebulizer was stopped and the filter unit was turned on externally. Each experiment was repeated at least 3 times. All particle concentration measurements were carried out using a TSI-UCPC model 3776.

Supplementary Information

1. Pressure Drop

The Darcy-like behaviour of the CNT filters was evaluated from the correlation between the pressure drop developed across the CNT filter and the face velocity running through it by normalizing the flow rates 0.1, 0.3, 0.5, 1.0, 1.5, 3 and 6 slpm to the surface area of 3.14×10⁻⁴ m² (20 mm disc diameter). According to Darcy's law and according to Equation 1 (see above) there should be a linear correlation between those and indeed such behaviour is portrayed in FIG. 11 for the 0.1, 0.2 and 7 g m⁻² samples. As seen from equation 1, the slopes of these trend lines (458.1, 183.2 and 10.3 m³ hr⁻¹ m⁻² kPa⁻¹ for the 0.1, 0.2 and 7 g m⁻² samples respectively) are the permittance values (k) as defined in the main text. Variance in pressure drops for each filter type across three different samples is low. This leads to a low standard deviation of the permittance values, represented graphically by the dashed lines. Producing these trend lines and evaluating their slope was the method from which permittance values for all the samples were calculated. As a reference, a commercial class H13 HEPA filter (Camfil) was examined. As seen from FIG. 11, the permittance (slope) of the commercial filter is of the same order of magnitude as the thin CNT filters with a calculated value of 604.3 m³ hr⁻¹ m⁻² kPa⁻¹. This result confirms that by further optimization it should be possible to create hybrid CNT filters that retain the filtration efficiency of HEPA filters while not imposing higher pressure drops. This will allow filtration system manufacturers to use their original design and only replace the commercial HEPA filters with hybrid CNT filters.

The intrinsic air permeability K of CNTs was calculated by linearizing Equation 1 as seen below:

$$ln k = ln ( \frac{K ρ}{μ} ) - ln {ρ}_{s} , \qquad ( S1 )$$

where k is the permittance, ρ is the CNT material density, μ is the dynamic viscosity of air, Δp is the pressure drop developed across the filtration matrix and ρₛ is the areal density. By plotting ln(k) as a function of ln(ρₛ), the intercept of the linear curve gave a value for

$$\frac{K ρ}{μ}$$

or 1.47×10⁻⁸±2.81×10⁻¹⁰ s. As ρ=4400±50 kg m⁻¹ s⁻¹ and μ=1.8×10⁻⁵ Pa s, it was subsequently calculated that the permeability of CNT material K=6.01×10⁻¹⁷±8.23×10⁻¹⁹ m².

2. Filtration Efficiency

Size selection of nanoparticles is most commonly done by selecting for a property known as mobility (B), then relating this to a particle's diameter. Mobility is defined as:

$$B = \frac{{C}_{c}}{3 πμ {d}_{m}} , \qquad ( S2 )$$

where dₘ is a particle's mobility-equivalent diameter which represents the diameter of a sphere possessing the same mobility (aerodynamic drag) as the particle in question. For spherical particles, the mobility diameter is equal to the physical diameter of the particle. μ is dynamic gas viscosity, and C_{c} is an empirical value known as the Cunningham slip correction. This is necessary to account for the change in drag experienced by very small particles as they no longer belong to the continuum flow regime but rather the transition or free molecular flow regimes. The Cunningham slip correction is:

$${C}_{c} = 1 + \frac{λ}{{d}_{m}} ( 2.34 + 1.05 {e}^{- 0.39 \frac{{d}_{m}}{λ}} ) {,}^{1} \qquad ( S3 )$$

where λ is the mean free path of a gas molecule. Further, a particle's electrical mobility (Z) can be represented by the product of its mobility and its charge:

$$Z = {n}_{q} eB = \frac{{n}_{q} {eC}_{c}}{3 πμ {d}_{m}} \qquad ( S4 )$$

where e is the elementary charge and n_{q} is the number of charges on the particle. Particle size is most commonly selected using an instrument known as a Differential Mobility Analyser (DMA) which classifies particles by their electrical mobility. If the charge state of the particles is known using the Weidensolar charge distribution for example (see Wiedensohler, A. An Approximation of the Bipolar Charge Distribution for Particles in the Submicron Size Range. J. Aerosol Sci. 1988, 19 (3), 387-389), the mobility equivalent diameter of the particle can be calculated. It is in this way that most size distributions and nearly-monodisperse particle populations are produced in the aerosol field.

Recently technologies have also been developed which classify particles by a property known as aerodynamic diameter (dₐ). This can be described as the diameter of a spherical particle having a density of 1000 kg/m³ which has the same settling velocity as the particle in question. Naturally a particle's dₐ not only involves the particle's physical dimensions but also its density since large, low-density particles can have the same settling velocity as smaller, denser particles. From Hinds, W. C. Aerosol Technology: Properties, Behaviour, and Measurement of Airborne Particles; Wiley, 1999, settling velocity (V_{TS}) can be used to relate aerodynamic and mobility diameters of a particle:

$${V}_{TS} = \frac{{ρ}_{0} {gd}_{a}^{2} {C}_{c} ( {d}_{a} )}{18 μ} = \frac{{ρ}_{eff} {gd}_{m}^{2} {C}_{c} ( {d}_{m} )}{18 μ} . \qquad ( S5 )$$

g is the acceleration due to gravity, ρ₀ is the unit density of 1000 kg/m³, and ρ_{eff} is effective density, equal to bulk density for spherical particles. The conversion between aerodynamic and mobility diameters can then be produced by simplifying the above equation.

$${d}_{a} = \sqrt{\frac{{ρ}_{eff} {C}_{c} ( {d}_{m} )}{{ρ}_{0} {C}_{c} ( {d}_{a} )}} {d}_{m} . \qquad ( S6 )$$

An Aerodynamic Aerosol Classifier (AAC) was used in this work to select nearly monodisperse particle sizes above 100 nm. Since it selects by aerodynamic diameter, these diameters were then converted to mobility diameter so results such as filtration efficiency could be directly related to results using a DMA. For example, if a mobility diameter of 2500 nm was desired for DOS particles (ρ=914 kg/m³), the equivalent aerodynamic diameter was calculated to be 2387 nm. The AAC was then programmed to select 2387 nm particles which result in the classification of particles having a mobility (and physical) diameter of 2500 nm. Under the tested conditions, the two dominant filtration mechanisms are interception and diffusion. The former occurs when a particle follows a gas streamline which passes less than one particle radius away from a filter fibre, resulting in contact and retention of the particle. Filtration via diffusion occurs as particles deviate from gas streamlines within the filter and contact the filter media through Brownian motion. Naturally interception captures large particles most effectively, since it is less likely that they follow a streamline that does not come within one particle radius of any filter fibre. Conversely diffusion is responsible for the efficient capture of small particles since these migrate via Brownian motion faster than large particles will. Small particles, therefore, deviate easily from streamlines and can contact nearby filter media. Traditional filters exhibit a characteristic minimum filtration efficiency that tends to be between 100 and 500 nm (FIG. 13). In this size range, neither the diffusion nor interception curves overlap leading to a total filtration efficiency curve that exhibits a ‘U’ profile, with the local minimum located at the so-called most penetrating particle size (MPPS). On the other hand, the unique feature of the CNT network in comparison to traditional filter media is that the fibres (ie bundles of ˜10 CNTs) are orders of magnitude smaller in diameter. The surface area of the fibres is very high, allowing even relatively large particles to be captured by diffusion (blue CNT diffusion curve). Similarly gaps and voids between fibres are also smaller than most existing filters and so particles must be very small to avoid being captured by interception (red CNT interception curve). What follows is a rather unique behaviour of filtration efficiency—there is no longer a size range where neither mechanism is notably ineffective and the characteristic U profile in filtration efficiency is not observed.

3. Electrothermal Analysis

To better demonstrate the effectiveness of the CNT filter as a fast-response heating element that efficiently uses resistive heating to evaporate captured aerosols rather than heat the filter material, a set of additional experiments were carried out. In these experiments, CNT strips (75×10 cm) mounted to the heating jig (FIG. 7a) were sprayed with approximately 5 μL of deionized water (DIW) at room temperature using an airbrush (Gocheer). The strips (0.2 and 7 g m⁻²) were heated to a setpoint of 80° C. (as described above) and the evaporation process was thermally recorded. As shown in FIG. 14, a frame-by-frame analysis to determine the time it took a sample to reach its terminal temperature was carried out (as described above). There was a 10-fold increase in the heating period from 30 to 75° C. for the “wet” 7 g m⁻² self-supporting CNT filter in comparison to a “dry” material (from 0.48 to 4.98 s) and a 2-fold increase for the same parameters with the 0.2 g m⁻² hybrid CNT filter. This shows that due to the low thermal inertia of the CNT filter, most of the resistive heating energy does not get wasted heating the CNT layer itself but rather the backing or the water coating the surface.

4. Virus Inactivation

Additional virus inactivation tests were carried out on an AAV9 virus serotype. The AAV9 was chosen as it is considered to be a stable virus (see Bennett, A.; Patel, S.; Mietzsch, M.; Jose, A.; Lins-Austin, B.; Jennifer, C. Y.; Bothner, B.; McKenna, R.; Agbandje-McKenna, M. Thermal Stability as a Determinant of AAV Serotype Identity. Mol. Ther. Clin. Dev. 2017, 6, 171-182). The AAV9-CMV-eGFP (Vector Biolabs) virus strain was used at a stock concentration of 6.3×10¹³ GC/mL. 0.2 μL droplets of AAV9 solution were pipetted on top of the 7 g m⁻² CNT strip for a volume of 2 μL, leading to a total of 1.26×10¹¹ genome copies (GC) added to each CNT strip. The strips were mounted on a bespoke heating jig (FIG. 7a) and were heated to 80° C. (as a minimum temperature) for a period of 0 (room temperature; RT), 30, 60 and 90 s. Each sample was run three times. The areas of the strip containing the droplets were cut and placed in 15 mL centrifuge tubes containing 5 mL of FreeStyle293 culture media. Media control containing 2 μL of AAV9 stock solution was prepared at a dilution ratio of 1:1000. All aliquots were stored at −80° C. before analysis. AAV9 Viral titer was performed using AAV real-time PCR titration kit (Takara Cat #6233) and quantification of intact AAV9 was performed using AAV Titration ELISA (ProGen Cat #PRAAV9), as per in kit instructions. As seen from FIG. 15, removal of AAV9 from the CNT strips is achievable using the method described above and total inactivation of the AAV9 was accomplished already after a heating period of 30 s as verified both by qPCR and ELISA.

5. Droplet and Aerosol Drying on a Heated CNT Mat

A computational model was developed to simulate the diffusion-controlled evaporation of a water droplet on a CNT mat. It was first validated by experimental results of droplets drying and then used to predict the overall drying time of aerosol droplets. A simplified pseudo-steady state analytical model under isothermal conditions was also used for results validation (see Hu and Wu supra).

COMSOL Model Features

Computer simulations were performed with the commercial software COMSOL Multiphysics. The model adopted a 2D axisymmetric geometry that revolved into a cylindrical domain including the CNT mat, the water droplet and the ambient air. The overall height of the domain was 1,600 times the height of the droplet, to reduce the influence of the ambient conditions, which were maintained constant at 25° C. and 60% relative humidity. The radius of the domain was 40 times the base radius of a 0.4 μL droplet unless otherwise specified, to be consistent with the relative length scale used in the experiment.

With a volumetric density around 500 kg m⁻³, the 7 g m⁻² CNT filter sample is estimated to have a thickness of 10 μm. The specific heat capacity is set to 800 J K⁻¹ kg⁻¹ (see Masarapu, C.; Henry, L. L.; Wei, B. Specific Heat of Aligned Multiwalled Carbon Nanotubes. Nanotechnology 2005, 16 (9), 1490-1494. (https://doi.org/10.1088/0957-448416/9/013)) and the in-plane and out-of-plane thermal conductivities to 130 W m⁻¹ K⁻¹ and 0.11 W m⁻¹ K⁻¹ respectively (see Zhang, X.; Tan, W.; Smail, F.; Volder, M. De; Fleck, N.; Boies, A. High-Fidelity Characterization on Anisotropic Thermal Conductivity of Carbon Nanotube Sheets and on Their Effects of Thermal Enhancement of Nanocomposites Related Content. Nanotechnology 2018, 29 (36), 365708. (https://doi.org/10.1088/1361-6528/aacd7b)).

Assumptions

It was assumed that the droplet kept a constant contact radius throughout the evaporation lifetime and maintained the shape of a spherical cap because the droplet was small enough for the gravity effect to be neglected. The moving mesh method was used to model the geometric deformation of the gas-liquid interface by assuming an average value of the moisture flux across the surface. It was also assumed that the influence of curvature, Stefan flow and kinetic effects can be ignored (see Semenov, S.; Starov, V. M.; Rubio, R. G.; Velarde, M. G. Computer Simulations of Evaporation of Pinned Sessile Droplets: Influence of Kinetic Effects. Langmuir 2012, 28 (43), 15203-15211). The model incorporated evaporative cooling and the Marangoni convection caused by the temperature gradient on the gas-liquid interface.

Governing Physics and their Boundary Conditions

Incompressible Navier-Stokes equations were used to model flows in both fluid phases, with no-slip and no-flux boundary conditions applied on both the liquid-solid and the gas-solid interfaces. The diffusion-controlled transfer of water vapor away from the liquid-gas interface was described by the dilute species transport equations in the air domain. The moisture content was set to be at ambient conditions on the top and radial domain boundaries. A no-flux boundary condition was applied on the gas-solid interface and the gas-liquid interface was at vapor-liquid equilibrium. The heat transfer equations were applied over all three phases. The top and radial domain boundaries were at a fixed temperature. The bottom domain boundary was subject to natural convection with a length scale of 40 mm, the width of the mat used in the experiment. Both surfaces of the mat dissipated heat via radiation with a unit emissivity. The CNT mat was supplied with input power, the value of which was determined such that the steady-state temperature reached 80° C. in the absence of evaporation, to be consistent with the result shown in FIG. 7d.

Simulation Regarding Evaporation Time as a Function of Aerosol Droplet Surface Concentration

In addition to the base case model as described above, the effect of the surface concentration of aerosol droplets was also explored. Assuming that the filter captures all droplets in the inlet flow and that no evaporation takes place outside the active heating cycle, the surface concentration of aerosol droplets at the onset of active heating can be derived under the ‘worst-case scenario’. In other words, the evaporation time required under this scenario would be a safe estimate.

A flowrate (Q) of 120 m³ h⁻¹ and a total area (A) of 1.235 m² were used, as taken from the normal experimental operating conditions. The droplet concentration in the air (c) was assumed to be 1 particle per cm³, an upper bound of the aerosol concentration produced by a human during speaking and coughing (see Johnson et al. Modality of Human Expired Aerosol Size Distributions. J. Aerosol Sci. 2011, 42 (12), 839-851. (https://doi.org/https://doi.org/10.1016/j.jaerosci.2011.07.009)). The active heating cycle (tₕ) was chosen to be 1 min, 5 min, 15 min or 60 min. The surface concentration, when translated into an input parameter for the model, became the length scale (Rₛ) of the CNT mat that was included in the simulation domain, as shown in equation S7 below. It is approximated that by using an average value of area per droplet, the simulation of one droplet can represent the overall evaporation time required to dry the filter after each collection cycle. The higher the surface concentration, the less area is occupied by each droplet, and hence the less power is available for evaporation. The result values are shown in Table S1.

$${R}_{s} = \sqrt{\frac{A}{{Qt}_{h} c π}} \qquad ( S7 )$$

TABLE S1
Surface concentration, length scale as
a function of the Active heating cycle

| Active heating | Surface concentration | Length scale |
|---|---|---|
| cycle, tₕ (min) | (# cm⁻²) | Rₛ (μm) |
| 1 | 9.72 × 10³ | 57.2 |
| 5 | 4.86 × 10⁴ | 25.6 |
| 15 | 1.46 × 10⁵ | 14.8 |
| 60 | 5.83 × 10⁵ | 7.39 |

6. Performance Evaluation of a Prototype Filtration Unit

A 20-jet collision nebulizer (CH Technologies) filled with a 20% w/w NaCl (>99.7%, Fisher Scientific) in DIW solution was used to produce a model aerosol in the confined test volume (8.0 m³). To analyse the size distribution of the NaCl nanocrystals, in situ particle measurements were conducted using a TSI-Scanning Mobility Particle Sizer 3080 (SMPS) system including a TSI-Ultrafine Condensation Particle Counter 3776 (UCPC) and TSI-Differential Mobility Analysers 3085 (DMA). FIG. 16 shows the average of 10 runs collecting the particle size distribution data (circles) which was fitted (line) to give a count geometric mean diameter and a geometric standard deviation of 118.77 and 2.08 nm respectively with a total particle concentration of 6.39×10⁵ cm⁻³. The CMD fits well with the size of a single SARS-CoV-2 single virion making this trial more realistic towards assessing the capability of the system to protect against COVID-19 transmission.

To better understand the behaviour of a filtration system, a basic numerical model was produced to solve the decay rates of aerosols in a confined volume. The model assumes a fully mixed room that is fully sealed to the environment. Based on this a particle mass conservation balance was made as seen in equation S8:

$${ρ}_{m} V \frac{\partial {C}_{v}}{\partial t} = \dot{V} {ρ}_{m} {PC}_{v} - \dot{V} {ρ}_{m} {C}_{v} \qquad ( S8 )$$

where ρₘ is the density of the particles, V is the room volume, Cᵥ is the aerosol number concentration, \dot{V} is the filtration system recycling volume flow and P is the penetration ratio of the filter. The solution for this first-order ODE is:

$$\frac{{C}_{v} ( t )}{{C}_{0}} = {e}^{- ( ACH \times Eff ) t} \qquad ( S9 )$$

where C₀ is the initial aerosol number concentration, ACH is the air changes per hour equal to \dot{V}/V, and Eff is the filtration efficiency equal to 1−P.

Due to the nature of air-recycling filtration systems, the filters do not need extremely high filtration performance in comparison to units based on a single pass (ie personal masks or process gas feed lines). By using the above model, it was possible to make a sensitivity analysis on how the filtration efficiency affects the temporal pollutant decay. The ACH value (22.99 hr⁻¹) used for this simulation was based on the flow rate (200 m³ hr⁻¹) and room size (8.0 m³) used when testing the real prototype unit. As seen in FIG. 17 the time taken for an H13 HEPA filter (green dot-dashed line) to purify the room by 99% is less than 10% faster in comparison to a lower grade E11 HEPA filter (blue dashed line). Using a non-HEPA filter (red line) increases this amount of time by only 25%.

1. A filter which is capable of sequestering an airborne virus comprising:
a framework; and
a self-supporting body of non-woven carbon nanotubes mounted on or in the framework.

2. The filter as claimed in claim 1 further comprising: means for inactivating the virus.

3. The filter as claimed in claim 2 wherein the means for inactivating the virus comprises an electric field generator for generating an electric field in the self-supporting body of nonwoven carbon nanotubes.

4. The filter as claimed in claim 3 wherein the electric field generator is an AC source.

5. The filter as claimed in claim 2 wherein the means for inactivating the virus comprises a thermal generator for generating heat in the self-supporting body of non-woven carbon nanotubes.

6. The filter as claimed in claim 2 wherein the means for inactivating the virus is a chemical means.

7. The filter as claimed in claim 1, wherein the self-supporting body of nonwoven carbon nanotubes is a monolayer of non-woven carbon nanotubes.

8. The filter as claimed in claim 1 wherein the self-supporting body of nonwoven carbon nanotubes is a laminate.

9. The filter as claimed in claim 8 wherein the laminate is a bilayer.

10. The filter as claimed in claim 9 wherein the bilayer is a layer of non-woven carbon nanotubes and a layer of a porous insulating material.

11. The filter as claimed in claim 10 wherein the porous insulating material is polyester.

12. The filter as claimed in any preceding claim wherein the areal density of the selfsupporting body of non-woven carbon nanotubes is in the range 0.1 to 14 gm-2.

13. An air treatment apparatus comprising:
a filter comprising:
a framework; and
a self-supporting body of non-woven carbon nanotubes mounted on or in the framework.

14. The air treatment apparatus as claimed in claim 13 which is an air conditioner, air purifier, air humidifier, respirator, ventilator, respiratory protective device, mask or breathing apparatus.

15. Use of a self-supporting body of non-woven carbon nanotubes as defined in claim 1.
